(19) United States
(12) Patent Application Publication
(10) Pub. No.: US 2026/0343411 A1
(43) Pub. Date: Oct. 29, 2026

(54) BANDWIDTH PART CONSIDERATIONS FOR MAIN RADIO AIDED BY A LOW-POWER WAKE UP RADIO

(71) Applicant: QUALCOMM Incorporated, San Diego, CA (US)

(72) Inventors: Ahmed ELSHAFIE, San Diego, CA (US); Huilin XU, Temecula, CA (US); Yuchul KIM, San Diego, CA (US); Linhai HE, San Diego, CA (US); Wei YANG, San Diego, CA (US); Chao WEI, Beijing (CN); Wanshi CHEN, San Diego, CA (US)

(21) Appl. No.: 19/101,584

(22) PCT Filed: Sep. 24, 2022
(86) PCT No.: PCT/CN2022/121132

§ 371 Date: Feb. 5, 2025

(51) Int. Cl. H04W 52/02

(52) U.S. Cl. CPC H04W 52/0235; H04W 52/028

(57) ABSTRACT

A method of wireless communication at a UE is disclosed herein. The method includes monitoring, via a first radio, a BWP based on a first configuration. The method includes switching, based on an occurrence of at least one condition, to monitoring a subband based on a second configuration and via a second radio having a lower power consumption than the first radio. The method includes waking up to receive communication in response to receiving, via the second radio, a wake up signal in the subband.

### TECHNICAL FIELD

The present disclosure relates generally to communication systems, and more particularly, to bandwidth parts (BWPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus include a memory and at least one processor coupled to the memory and, based at least in part on information stored in the memory, the at least one processor is configured to: monitor, via a first radio, a bandwidth part (BWP) based on a first configuration; switch, based on an occurrence of at least one condition, to monitoring a subband based on a second configuration and via a second radio having a lower power consumption than the first radio; and wake up to receive communication in response to receiving, via the second radio, a wake up signal in the subband.

In an aspect of the disclosure, a method, a computer-readable medium, and an apparatus for wireless communication at a network node are provided. The apparatus include a memory and at least one processor coupled to the memory and, based at least in part on information stored in the memory, the at least one processor is configured to: transmit, for a UE, a first configuration associated with a first radio of the UE that is associated with a first power consumption, where the first radio is associated with a BWP; transmit, for the UE, a second configuration associated with a second radio of the UE, where the second radio is associated with a second power consumption that is less than the first power consumption; and transmit, in a subband associated with the second radio of the UE, a wake up signal.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4A is a frequency diagram illustrating example aspects of BWPs.

FIG. 4B is a diagram illustrating an example of BWP adaptation.

FIG. 5 is a diagram illustrating an example of DCI based BWP switching and an example of timer based BWP switching.

FIG. 6 is a diagram illustrating an example of a main radio of a UE, a low-power wake up receiver (LP-WUR) of the UE, and timelines associated with the main radio and the LP-WUR.

FIG. 7 is a diagram illustrating examples of BWPs and LP-WUR BWPs within the BWPs.

FIG. 8 is a diagram illustrating an example timeline of monitoring a BWP and a LP-WUR BWP via a main radio and a LP-WUR.

FIG. 9 is a diagram illustrating an example of a main radio configuration and a LP-WUR configuration.

FIG. 10 is a diagram illustrating example BWPs, LP-WUR BWPs, and timers.

FIG. 11 is a diagram illustrating an example timeline depicting switching between monitoring BWPs and LP-WUR BWPs based on an expiration of a first timer and a second timer.

FIG. 12 is a diagram illustrating an example timeline depicting switching between monitoring BWPs and LP-WUR BWPs based on an expiration of a first timer, a second timer, and a third timer.

FIG. 13 is a diagram illustrating an example of a downlink control information (DCI).

FIG. 14 is a diagram illustrating example communications between a UE and a base station.

FIG. 15 is a flowchart of a method of wireless communication in accordance with aspects of the present disclosure.

FIG. 16 is a flowchart of a method of wireless communication in accordance with aspects of the present disclosure.

FIG. 17 is a flowchart of a method of wireless communication in accordance with aspects of the present disclosure.

FIG. 18 is a flowchart of a method of wireless communication in accordance with aspects of the present disclosure.

FIG. 19 is a diagram illustrating an example of a hardware implementation for an example apparatus and/or UE configured to perform aspects of the present disclosure.

FIG. 20 is a diagram illustrating an example of a hardware implementation for an example network entity configured to perform aspects of the present disclosure.

### DETAILED DESCRIPTION

A UE may be configured with multiple radios, which may have different power consumptions. As an example, the UE may include a main radio and a LP-WUR, where the main radio may be associated with a higher power consumption than the LP-WUR. The UE may place the main radio in a sleep state and may monitor for a wake up signal in a BWP via the LP-WUR. Monitoring a BWP for a wake up signal consumes power. Furthermore, if the wake up signal is to be received in a different BWP than a current BWP, the UE may have to perform a BWP switch, which may involve radio frequency tuning, using different antennas, and/or ascertaining channel characteristics associated with the different BWP. Various technologies pertaining to BWPs and LP-WUR BWPs to achieve improved power savings at a UE are disclosed herein. In an example, a UE monitors, via a first radio, a BWP based on a first configuration. The UE switches, based on an occurrence of at least one condition, to monitoring a subband based on a second configuration and via a second radio having a lower power consumption than the first radio. The UE wakes up to receive communication in response to receiving, via the second radio, a wake up signal in the subband. In switching to monitoring the subband via the second radio (i.e., a LP-WUR), the UE may consume less power in comparison to monitoring a wider BWP using the main radio. Furthermore, by monitoring a subband of a BWP, the UE may avoid BWP switching, avoid radio frequency tuning or retuning. The subband monitoring with the LP-WUR may reuse antennas and/or channel characteristics, e.g., associated with the BWP.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

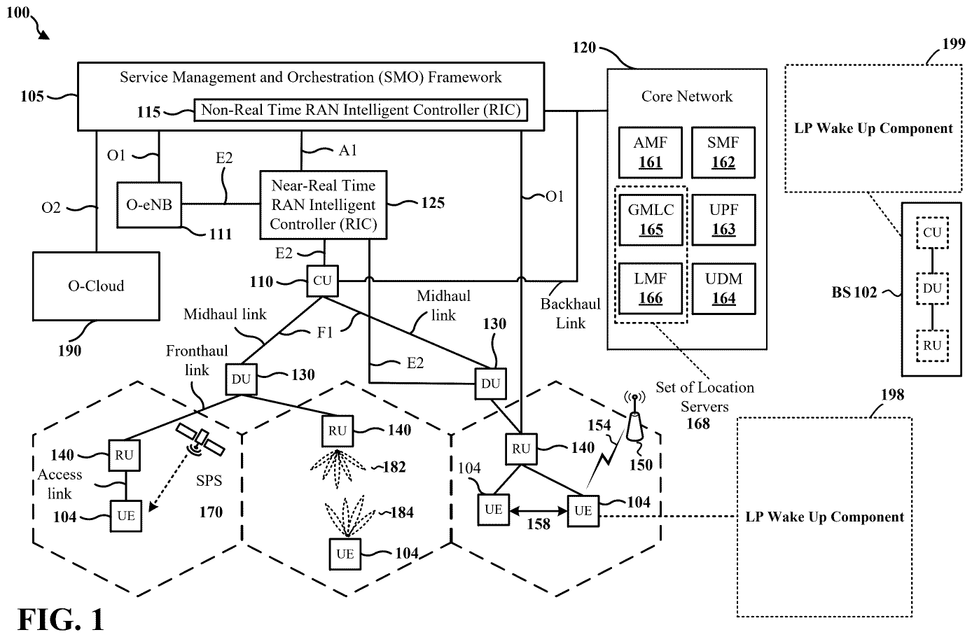

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an 01 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a LP wake up component 198 that is configured to monitor, via a first radio, a BWP based on a first configuration, switch, based on an occurrence of at least one condition, to monitoring a subband based on a second configuration and via a second radio having a lower power consumption than the first radio, and wake up to receive communication in response to receiving, via the second radio, a wake up signal in the subband. In certain aspects, the base station 102 may include a LP wake up component 199 that is configured to transmit, for a UE, a first configuration associated with a first radio of the UE that is associated with a first power consumption, where the first radio is associated with a BWP, transmit, for the UE, a second configuration associated with a second radio of the UE, where the second radio is associated with a second power consumption that is less than the first power consumption, and transmit, in a subband associated with the second radio of the UE, a wake up signal. Although the following description may be focused on 5G NR, the concepts described herein may be applicable to other similar areas, such as LTE, LTE-A, CDMA, GSM, and other wireless technologies.

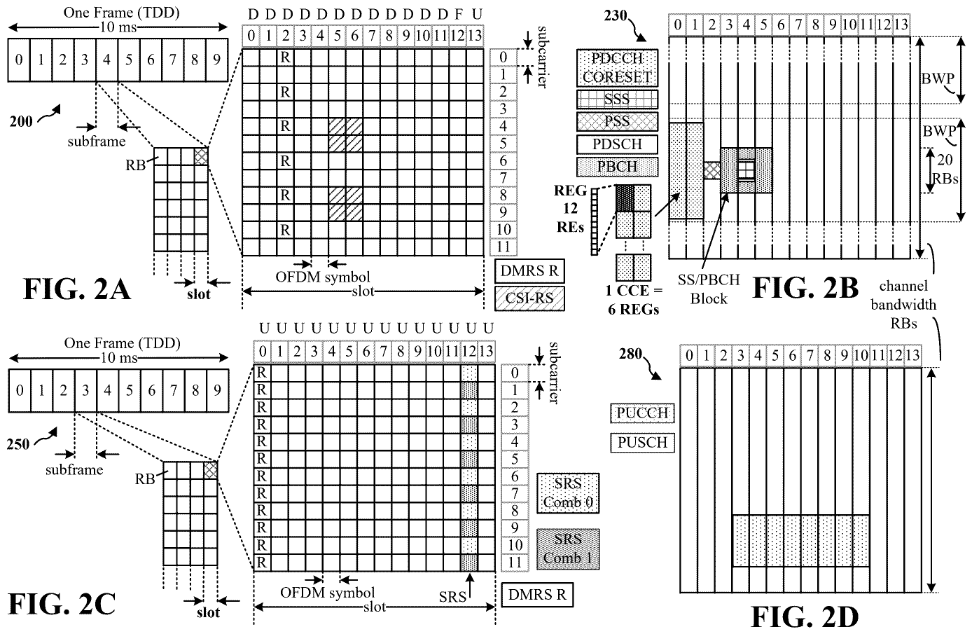

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

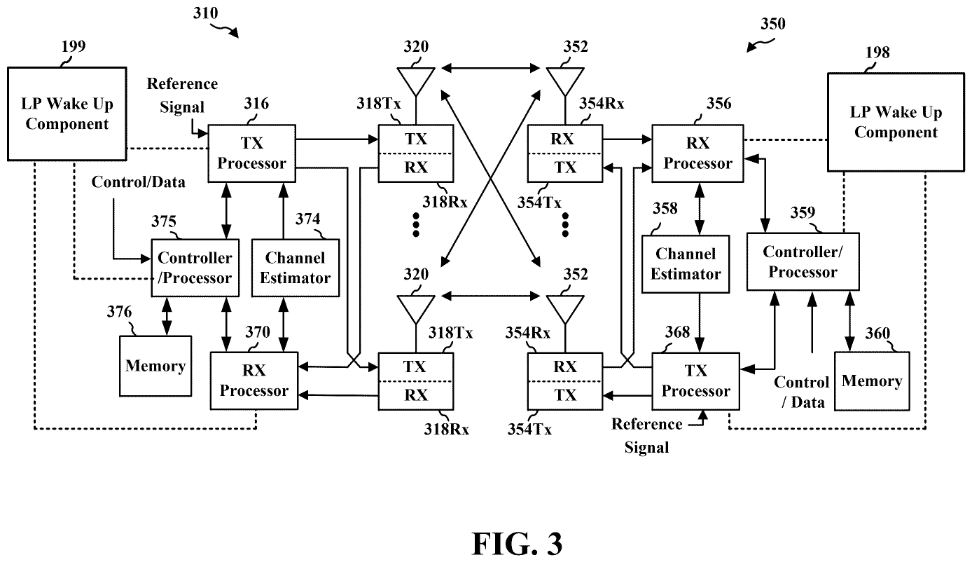

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the LP wake up component 198 of FIG. 1.

At least one of the TX processor 316, the RX processor 370, and the controller/processor 375 may be configured to perform aspects in connection with the LP wake up component 199 of FIG. 1.

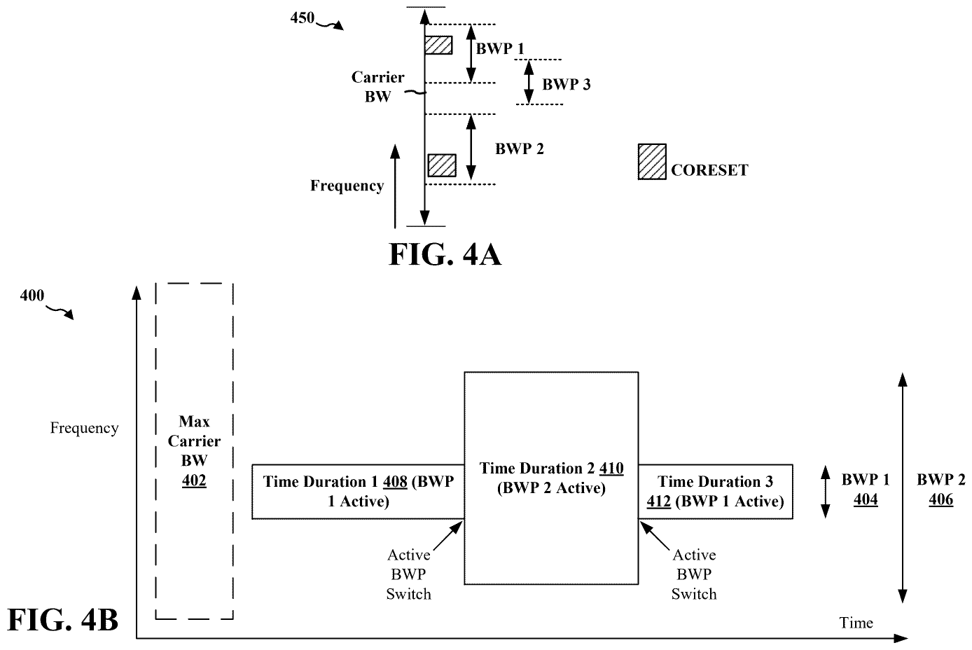

A UE may be configured with multiple BWPs within a carrier frequency. FIG. 4A includes a frequency diagram 450 that illustrates an example of three BWPs, e.g., BWP 1, BWP2, and BWP3, each spanning a set of frequency resources, e.g., a set of PRBs within a carrier bandwidth. FIG. 4A illustrates that the BWPs may be overlapping or non-overlapping. A BWP may be activated for the UE from the set of configured BWPs. The UE may not be expected to receive PDSCH, PDCCH, CSI-RS, TRS, etc. outside of an active downlink BWP. The UE may not transmit PUSCH or PUCCH outside of an active uplink BWP. In some aspects, the UE may receive an indication from a network to switch from a first active BWP to a second active BWP from the set of configured BWPs. In some aspects, the UE may switch BWPs based on the occurrence of an event, such as an expiration of a timer. As illustrated in FIG. 4A, each downlink BWP may include a control resource set (CORESET) corresponds to a configurable set of physical resources in time and frequency that a UE uses to monitor for PDCCH/DCI when the corresponding BWP is activated. For example, if the UE receives an indication to switch to BWP 1 the UE may monitor for control signaling in the corresponding CORESET in BWP 1. If the UE receives an indication to switch to BWP 2, the UE may monitor for control signaling in the CORESET in BWP 2. FIG. 4B is a diagram 400 illustrating an example of BWP adaptation. In some wireless communication systems (e.g., 5G NR), some UEs may not support transmitting/receiving data/signals over an entirety of a maximum carrier bandwidth or may benefit from transmitting, receiving, and monitoring over a reduced bandwidth. A BWP may refer to a bandwidth that is less than or equal to a maximum carrier bandwidth. In an example, a UE may be configured with up to four BWPs having different frequency ranges and one BWP may be active for the UE at a particular time. A BWP may be characterized by a numerology (subcarrier spacing and a cyclic prefix) and a set of consecutive resource blocks in the numerology of the BWP. BWP adaptation, e.g., changing from using one active BWP to using a different BWP for communication with the network, may also be referred to as BWP switching.

The diagram 400 depicts an example of resources in frequency and time. The diagram depicts a maximum carrier bandwidth 402. The diagram also depicts a first BWP 404 and a second BWP 406. In an example, the first BWP 404 may have a first bandwidth and the second BWP 406 may have a second bandwidth. In an example, the second bandwidth may be greater than the first bandwidth. In an example, a UE may utilize the first BWP 404 for monitoring control channels and the UE may utilize the second BWP 406 for reception/transmission of data. The UE may switch BWPs based on an expiration of one or more timers or based on receiving a DCI from a base station. In an example, one BWP may be active at a time. For instance, the first BWP 404 may be active for a first time duration 408. At the end of the first time duration 408, the UE may switch the active BWP to the second BWP 406. The second BWP 406 may be active for a second time duration 410. At the end of the second time duration 410, the UE may switch the active BWP back to the first BWP 404. The first BWP 404 may then be active for a third time duration 412. The different BWPs to which the UE switches may be overlapping, as shown in FIG. 4B or may be non-overlapping, e.g., such as a change from BWP1 in FIG. 4A to BWP2 in FIG. 4A.

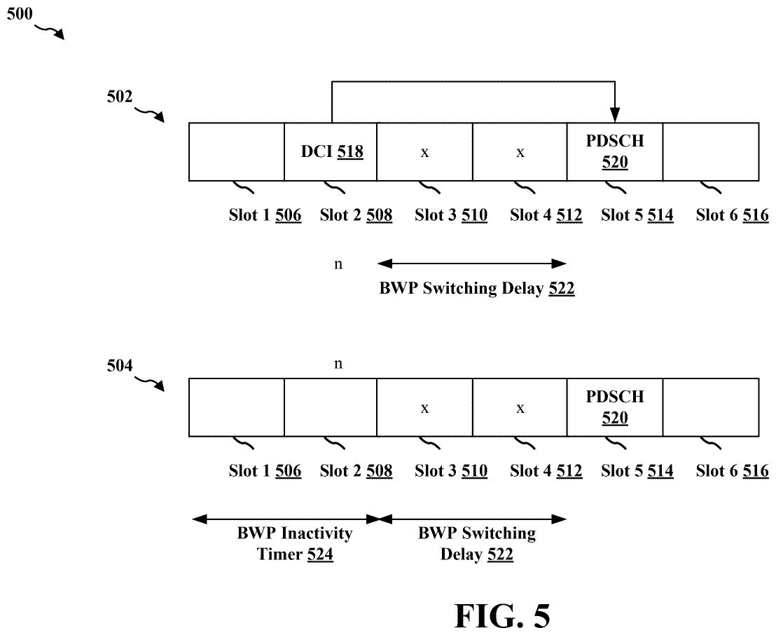

FIG. 5 is a diagram 500 illustrating an example of DCI based BWP switching 502 and an example of timer based BWP switching 504. In the DCI based BWP switching 502, a DCI can trigger BWP switching at the UE from a transmitting or receiving communication (e.g., PDCCH/PUCCH or PDSCH/PUSCH) or monitoring for such communication in frequency resources associated with a current BWP to resources associated with a new BWP. The DCI based BWP switching 502 may also be referred to as layer 1 (L1) based BWP switching.

In the example of the DCI based BWP switching 502, a first slot 506, a second slot 508, a third slot 510, a fourth slot 512, a fifth slot 514, and a sixth slot 516 are illustrated. A DCI 518 is received in the second slot 508. A UE may switch to a new BWP to receive a PDSCH transmission (e.g., a PDSCH transmission 520) or transmit a PUSCH transmission after a beginning of a downlink slot n (e.g., n=2). The UE may experience a delay, e.g., a gap in time, between communication on the prior BWP and communication on the new BWP. For example, the example at 502 shows that the DCI 518 is received after a BWP switching delay 522. In the example depicted in the diagram 500, the BWP switching delay 522 may be two slots. The UE may not transmit or receive data/signals during the BWP switching delay 522, e.g., which the UE is preparing for communication in the new BWP. For instance, the UE may not receive data/signals in the third slot 510 or the fourth slot 512. The BWP switching delay 522 may also be referred to as T_{BWPswitchingDelay}.

In the example of the timer based BWP switching shown at 504, a BWP inactivity timer 524 associated with a UE expires at the end of the second slot 508. In response to the BWP inactivity timer expiration, the UE may switch to a new BWP to receive a PDSCH transmission (e.g., the PDSCH transmission 520) or to transmit a PUSCH transmission after a slot corresponding to the BWP inactivity timer 524 expiration (i.e., after the beginning of a downlink slot n after the BWP inactivity timer 524 expires). As illustrated, there may be a switching delay 522 while the UE switches between the BWPs. The UE may not transmit or receive data/signals during the BWP switching delay 522. For instance, the UE may not receive data/signals in the third slot 510 or the fourth slot 512.

The BWP switching delay 522 may depend on a numerology (u), a slot length, and a UE capability (e.g., Type 1 or Type 2). If a BWP switch involves a changing of a SCS, a BWP delay may be determined by a smaller SCS between a current SCS for a current BWP and a new SCS for a new BWP. Table 2 details various aspects of BWP switching delays.

TABLE 2
Numerology, NR Slot Length, and BWP Switching Delay

| | NR Slot | BWP Switching Delay T_{BWPswitchDelay} (slots) | |
|---|---|---|---|
| μ | length (ms) | Type 1 | Type 2 |
| 0 | 1 | 1 | 3 |
| 1 | 0.5 | 2 | 5 |
| 2 | 0.25 | 3 | 9 |
| 3 | 0.125 | 6 | 18 |

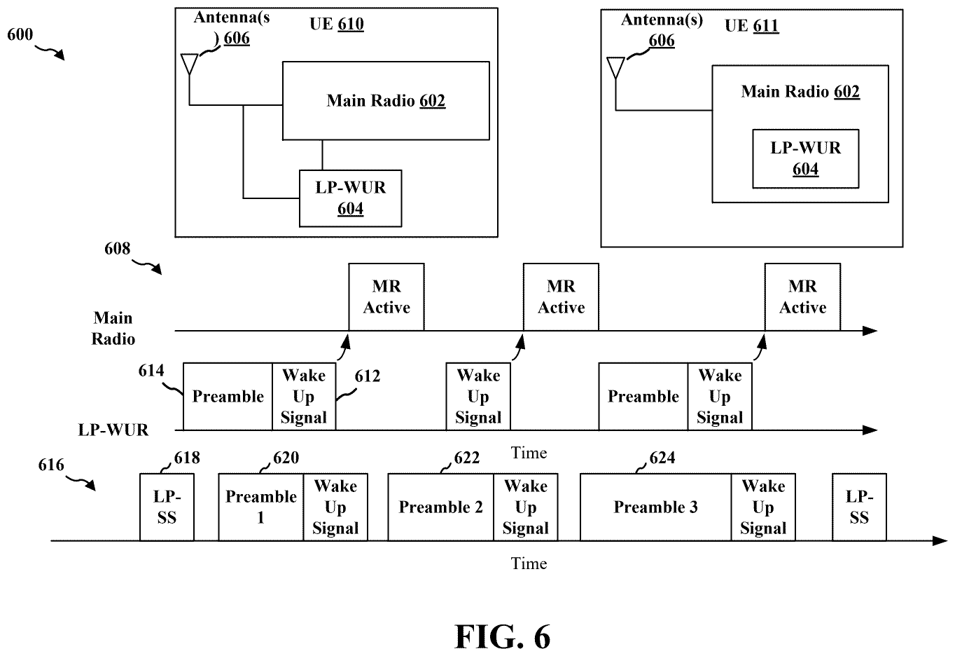

FIG. 6 is a diagram 600 illustrating an example of a main radio 602 of a UE 610, a low-power wake up receiver (LP-WUR) 604 of the UE 610, and timelines 608 associated with the main radio and the LP-WUR. FIG. 6 also illustrates an example of a UE 611 in which the LP-WUR 604 may include a subset of components of the main radio 602. In an example, the main radio 602 may be associated with general transmission/reception of data/signals at the UE 610. The main radio 602 and the LP-WUR may operate in different states. The main radio 602 may be in a sleep state or an active state. In an example, the main radio 602 may not be able to transmit/receive data/signals while in the sleep state. In an example, the main radio 602 may be able to transmit/receive data/signals while in the active state. The LP-WUR 604 may be a companion receiver to the main radio 602. The LP-WUR 604 may monitor for wake up signals while the main radio 602 is in a sleep state. In an example, the main radio 602 may be associated with a first power consumption and the LP-WUR 604 may be associated with a second power consumption, where the first power consumption is greater than the second power consumption. The LP-WUR 604 may monitor for a signal that indicates for the UE to wake up the main radio 602, e.g., a wake up signal (e.g., a low-power wake up signal (LP-WUS). The LP-WUR 604 may consume less power compared to the main radio 602 by design, that is, the LP-WUR 604 may be powered separately from the main radio 602 and may utilize blocks associated with less power consumption compared to blocks associated with the main radio 602. In some aspects, the LP-WUS may utilize a simplified modulation scheme in comparison to a WUS (e.g., which may be referred to as a higher power WUS). As an example, the LP-WUS may be based on an on-off keying (OOK) modulation scheme. The OOK modulation scheme may lead to a smaller a payload size for an LP-WUS. By utilizing the LP-WUR 604 to monitor for wake up signals (as opposed to the main radio 602), the UE 610 may avoid waking up the main radio 602 and hence may reduce power consumption. Furthermore, as the LP-WUR 604 may consume less power compared to the main radio 602, the LP-WUR 604 may allow for more frequent wake up signal monitoring and hence may reduce an average latency at the UE 610. The main radio 602 and the LP-WUR 604 may be connected to one or more antennas 606. The main radio 602 and the LP-WUR 604 may be connected to one or more of a radio-frequency (RF) module or component, a hardware (HW) module or component, a software (SW) module or component, and/or a firmware (FW) module or component.

As illustrated in the timeline 608, the LP-WUR 604 may receive a wake up signal 612 (e.g., a LP-WUS). Upon receiving the wake up signal 612, the UE may wake up the main radio 602. As an example, the LP-WUR 604 may transmit a signal that transitions the main radio 602 from a sleep state to an active state such that the main radio 602 may transmit/receive data/signals.

In some aspects, a preamble 614 may be a part of or may be added to the wake up signal 612. The preamble 614 may be a synchronization sequence or a signal. The preamble 614 may be configured under a wake up signal configuration. The wake up signal 612 may be associated with a first periodicity and the preamble 614 may be associated with a second periodicity. The first periodicity may be the same as, similar to, or different from the second periodicity. The preamble 614 may be associated with functionality similar to functionality associated with a low-power synchronization signal (LP-SS). The preamble 614 may precede a wake up signal. A design, number of symbols, used sequence, or scrambling identifier (ID) of the preamble 614 may be the same as or different than those of a LP-SS.

In some aspects, a size/length of a preamble may vary based on how close in time the preamble is separated from a LP-SS. For instance, FIG. 6 depicts a timeline 616 that includes LP-SSs, preambles, and wake up signals. In an example, a first preamble 620 may have a first size/length based on a time difference between a time at which the LP-SS 618 is transmitted and a time at which the first preamble 620 is transmitted, the second preamble 622 may have a second size/length based on a time difference between a time at which the LP-SS 618 is transmitted and a time at which the second preamble 622 is transmitted, and the third preamble 624 may have a third size/length based on a time difference between a time at which the LP-SS 618 is transmitted and a time at which the third preamble 624 is transmitted. In an example, the first size/length may be less than the or the same as the second size/length. In an example, the second size/length may be greater than or the same as the first size/length and the second size/length may be less than or the same as third size/length. In an example, the third size/length may be greater than or the same as the second size/length. In an example, a preamble occurring near a LP-SS may be shorter in comparison to another preamble as a UE may utilize the LP-SS for a majority of a synchronization process. In one aspect, a preamble after a LP-SS may be cancelled or not transmitted (i.e., a preamble with a size/length of zero). This may depend on a time between a LP-SS and the preamble and may be indicated in a configuration. In an example, a preamble may be cancelled/not transmitted based on L1/L2/L3 signaling transmitted from a base station (e.g., a gNB) to a UE.

The LP-WUR 604 may be useful for Internet of Things (IoT) devices. In an example, the UE 610 may be an IoT device. For instance, the LP-WUR 604 may be useful for IoT devices that are associated with low power consumption and that are latency tolerant (e.g., periodic sensing, metering, etc.). The main radio 602 and the LP-WUR 604 may be duty cycled to reduce power consumption. A longer latency may be associated with a lower power consumption by the UE 610. Example scenarios associated with lower latency characteristics include actuator control, on-demand sensing application and/or on-demand location.

As noted above, a UE may be configured with a main radio and a LP-WUR, where the main radio may be associated with a higher power consumption than the LP-WUR. The UE may place the main radio in a sleep state and may monitor for a wake up signal in a BWP via the LP-WUR. However, monitoring a BWP for a wake up signal may consume power. Furthermore, if the wake up signal is to be received in a different BWP than a current BWP, the UE may have to perform a BWP switch, which may involve radio frequency tuning, using different antennas, and/or ascertaining channel characteristics associated with the different BWP. Various technologies pertaining to BWPs and LP-WUR BWPs to achieve improved power savings at a UE are disclosed herein. In an example, a UE monitors, via a first radio, a BWP based on a first configuration. The UE switches, based on an occurrence of at least one condition, to monitoring a subband based on a second configuration and via a second radio having a lower power consumption than the first radio. The UE wakes up to receive communication in response to receiving, via the second radio, a wake up signal in the subband. In switching to monitoring the subband via the second radio (i.e., a LP-WUR), the UE may consume less power in comparison to monitoring a wider BWP using the main radio. Furthermore, by monitoring a subband of a BWP, the UE may avoid BWP switching, avoid radio frequency tuning or retuning. The subband monitoring with the LP-WUR may reuse antennas and/or channel characteristics, e.g., associated with the BWP.

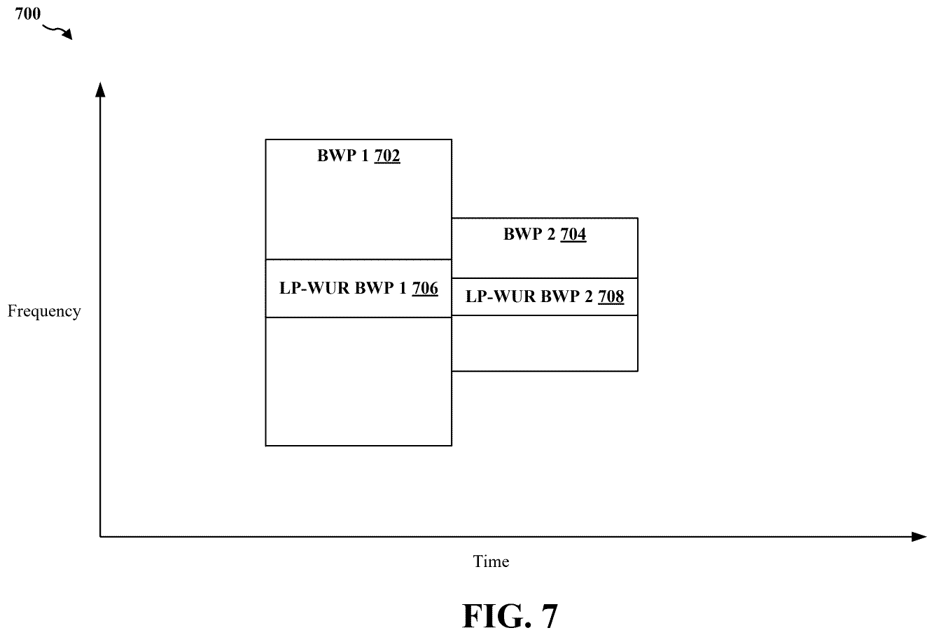

FIG. 7 is a diagram 700 illustrating examples of BWPs and LP-WUR BWPs within the BWPs. The diagram 700 depicts a first BWP 702 and a second BWP 704. The first BWP 702 and the second BWP 704 may be associated with a first configuration of the UE. In an example, the first BWP 702 and the second BWP 704 may be configured/defined for a main radio of the UE (e.g., the main radio 602). The diagram 700 also depicts a first LP-WUR BWP 706 in the first BWP 702 and a second LP-WUR BWP 708 in the second BWP 704. The first LP-WUR BWP 706 and the second LP-WUR BWP 708 may also be referred to as subbands of the first BWP 702 and the second BWP 704, respectively. Stated differently, the first LP-WUR BWP 706 may occupy less bandwidth than bandwidth occupied by the first BWP 702 and the second LP-WUR BWP 708 may occupy less bandwidth than bandwidth occupied by the second BWP 704. The first LP-WUR BWP 706 and the second LP-WUR BWP 708 may be associated with a second configuration of the UE. In an example, the first LP-WUR BWP 706 and the second LP-WUR BWP 708 may be configured/defined for a LP-WUR of the UE (e.g., the LP-WUR 604).

As will be described in greater detail below, a main radio (e.g., the main radio 602) of a UE may monitor a BWP (e.g., the first BWP 702) for data/signals. Upon an occurrence of a condition (or conditions), the UE may switch to monitoring a LP-WUR BWP (e.g., the first LP-WUR BWP 706 or the second LP-WUR BWP 708) for the data/signals. In an example, the condition may be or include one or more timers expiring and/or receiving a DCI.

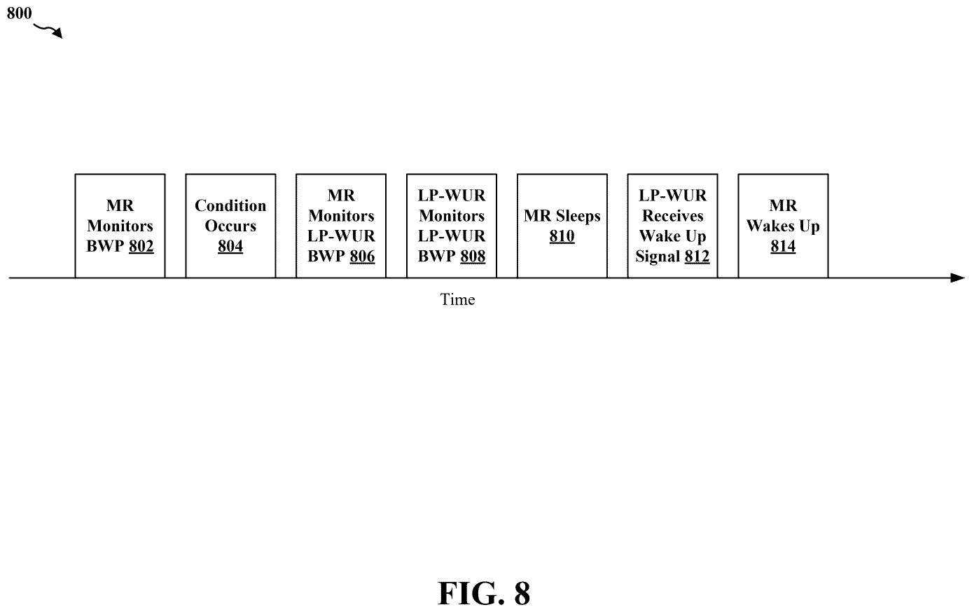

FIG. 8 is a diagram 800 illustrating an example timeline of monitoring a BWP and a LP-WUR BWP via a main radio and a LP-WUR of a UE. In an example, the BWP may be the first BWP 702 or the second BWP 704, the LP-WUR BWP may be the first LP-WUR BWP 706 or the second LP-WUR BWP 708, the main radio may be the main radio 602 of the UE 610, and the LP-WUR may be the LP-WUR 604 of the UE 610.

At 802, the UE may monitor the BWP via the main radio (referred to as “MR” in FIG. 8) of the UE. Stated differently, the BWP may be an active BWP and the UE may monitor the active BWP for data/signals via the main radio. At 804, the UE may detect that a condition occurs. In an example, the condition may be an expiration of a timer (e.g., a BWP timer or another timer). In another example, the condition may be receiving a DCI that indicates that BWP switching is to occur.

At 806, upon the UE detecting that the condition has occurred, the UE may switch to monitoring the LP-WUR BWP via the main radio. At 808, the UE may monitor the LP-WUR BWP via the LP-WUR. At 810, subsequent to, or concurrently with, monitoring the LP-WUR BWP via the LP-WUR, the UE may place the main radio in a sleep state. At 812, the LP-WUR of the UE may receive a wake up signal in the LP-WUR BWP. At 814, the UE may wake up the main radio based on the LP-WUR receiving the wake up signal in the LP-WUR BWP.

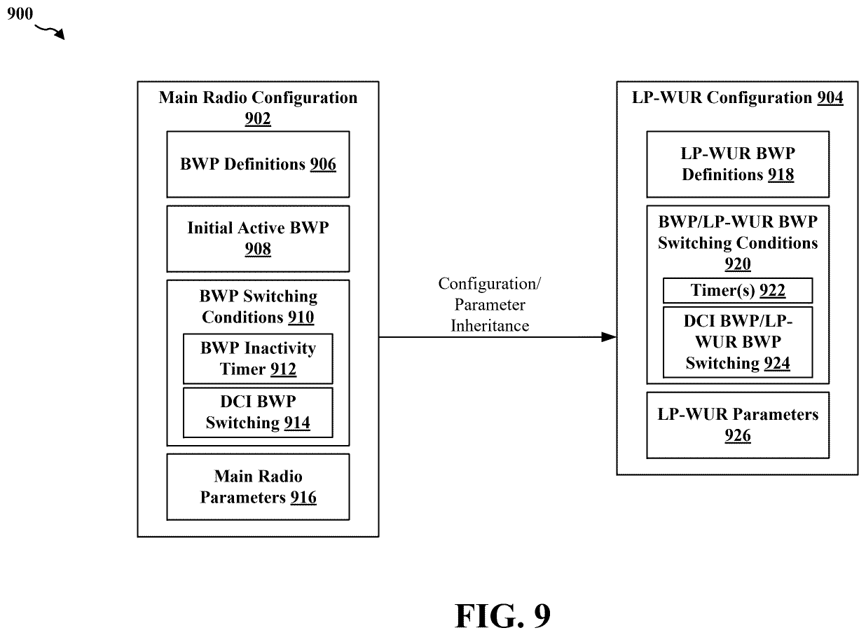

FIG. 9 is a diagram 900 illustrating an example of a main radio configuration 902 and a LP-WUR configuration 904. A UE (e.g., the UE 610) may receive the main radio configuration 902 and/or the LP-WUR configuration 904 via RRC signaling. In an example, the main radio configuration 902 may be associated with the main radio 602 and the LP-WUR configuration 904 may be associated with the LP-WUR 604.

The main radio configuration 902 may include BWP definitions 906 that define a plurality of BWPs (e.g., four BWPs). Each of the plurality of BWPs may have a different associated bandwidth. The plurality of BWPs may be associated with the main radio of the UE. The main radio configuration may include an indication of an initial active BWP 908 in the plurality of BWPs. The main radio configuration 902 may include BWP switching conditions 910. The BWP switching conditions 910 may include an indication of a BWP inactivity timer 912. For instance, the indication of the BWP inactivity timer 912 may include a timer duration. The BWP switching conditions 910 may also include characteristics related to DCI BWP switching 914.

The main radio configuration 902 may indicate main radio parameters 916 (e.g., for the main radio 602) The main radio parameters 916 may also indicate characteristics of wake up monitoring occasions, characteristics of reference signals, characteristics of synchronization signals, characteristics of wake up signals, characteristics of preamble signals associated with the wake up signals, characteristics associated with PDCCH monitoring, characteristics associated with channel state information (CSI) or CSI-RS, characteristics associated with SRS, or characteristics associated with transmission and/or reception of data.

The LP-WUR configuration 904 may include LP-WUR BWP definitions 918. The LP-WUR BWP definitions 918 may define a plurality of LP-WUR BWPs, where each LP-WUR BWP in the plurality of LP-WUR BWPs may be within one of the plurality of BWPs defined in the BWP definitions 906. The LP-WUR configuration 904 may include BWP/LP-WUR BWP switching conditions 920. The BWP/LP-WUR BWP switching conditions 920 may include an indication of one or more timers 922. The one or more timers 922 may include a BWP inactivity timer, other timers, a BWP switching delay, etc. The BWP/LP-WUR BWP switching conditions 920 may include characteristics related to DCI BW/LP-WUR BWP switching 924.

The LP-WUR configuration 904 may indicate LP-WUR parameters 926. The LP-WUR parameters 926 may be associated with a LP-WUR (e.g., the LP-WUR 604). The LP-WUR parameters 926 may also include one or more parameters that may be inherited from, e.g., be based on or share, the main radio parameters 916. In an example, the LP-WUR configuration 904 may inherit, e.g., be based on or share, the main radio parameters 916 and may include modifications to the inherited, e.g., shared, parameters. In an example, the LP-WUR parameters 926 may indicate characteristics of wake up monitoring occasions (e.g., LP-WUS monitoring occasions), characteristics of reference signals (e.g., low-power reference signals (LP-RS) and repetitions of LP-RS), such as characteristics used for channel estimation and/or time/frequency error correction, characteristics of synchronization signals (e.g., low-power synchronization signals (LP-SS), such as characteristics used for time and frequency synchronization, characteristics of wake up signals (e.g., repetitions of a LP-WUS), characteristics of preamble signals associated with the wake up signals, characteristics associated with PDCCH monitoring (e.g., a search space set group (SSSG) list or an index to monitor a PDCCH), characteristics associated with CSI or CSI-RS (e.g., characteristics associated with CSI-RS monitoring and transmission of CSI reports), characteristics associated with SRS (e.g., characteristics associated with SRS configuration and transmission), characteristics associated with configured grant (CG) and/or semi-persistent scheduling (SPS) (e.g., CG/SPS configuration of CGs and SPSs) or characteristics associated with transmission and/or reception of data (e.g., characteristics associated with transmission and/or reception of (small) data). The LP-WUR configuration 904 may also inherit, or share, other aspects of the main radio configuration 902 (e.g., the indication of the BWP inactivity timer 912).

In one aspect, the main radio configuration 902 (and by extension the main radio parameters 916) and the LP-WUR configuration 904 (and by extension the LP-WUR parameters 926) may be based on UE reported capabilities. The UE reported capabilities may include a type of configuration that may be used for each radio (e.g., a main radio and a LP-WUR) during a certain time duration or an overall time. The UE reported capability may also indicate that a wake up receiver (WUR), for instance, a LP-WUR, may support (1) PDCCH based DCI (e.g., a polar coded DCI used in NR), (2) sequence based signals, such as PUCCH 0 or other reference signals that may be used for wake up (e.g., a DFT, Zadoff-Chu sequence, a Gold transform, a Hadamard transform, etc.), or (3) OOK/amplitude-shift keying (ASK)/frequency shift keying (FSK) based modulated waveforms (e.g., OFDM waveforms). PDCCH based DCI may be associated with a greater power consumption than sequence based signals and sequence based signals may be associated with a greater power consumption than OOK/ASK/FSK based modulated waveforms. PDCCH based DCI may be associated with a greater/higher sensitivity or network coverage than sequence based signals and sequence based signals may be associated with a greater/higher sensitivity or network coverage than OOK/ASK/FSK based modulated waveforms.

The UE reported capabilities may be dynamic and indicated in layer 1, layer 2, or layer 3 signaling from time to time. The UE reported capabilities may be indicated in a capability information message or in user-assistance information (e.g., a RRC indication). A network and or a UE may cooperatively decide (e.g., based on an agreement) as to whether PDCCH based DCI, sequence-based signals, or OOK/ASK/FSK based modulated waveforms may be used from time to time (e.g., during the next time when a LP-WUR monitors for wakeup signals or paging signals). The UE may be configured by multiple configurations for LP-WUS if more than one of PDCCH based DCI, sequence based signals, or OOK/ASK/FSK based modulated waveforms are supported by the WUR. In an example, PDCCH based DCI, sequence based signals, or OOK/ASK/FSK based modulated waveforms may be utilized by a UE based on at least one of a location of the UE (e.g., UE being near or far cell from the serving cell), UE's mobility, sensitivity characteristic associated with the NW at a certain time or time duration, a power state of the UE (e.g., a UE cannot process certain type of signals (e.g., polar coded DCI) or use high power for processing), or a sleep mode of a main radio of the UE. The UE, a base station (e.g., a gNB), or a network may determine that the UE is to utilize PDCCH based DCI, sequence based signals, or OOK/ASK/FSK based modulated waveforms at a particular time. A network may use one or more of LP-WUS types (e.g., PDCCH based DCI, sequence based signals, or OOK/ASK/FSK based modulated waveforms) based on UE reported capabilities at a certain time and network sensitivity and coverage characteristics. The UE may monitor a WUS signal based on UE reported capabilities. In some cases, a UE that is capable of processing multiple WUSs may be signaled by the network to use a first type of LP-WUS during a first time or a first time duration, and then use a second type of LP-WUS during a second time or a second duration. In some cases, the network may send more than one WUS type and the UE may select which WUS type the UE may monitor and process, based on the UE reported capabilities. In some cases, the network decision may be based on UE mobility (e.g., based on UE reporting or measured by UL sounding signals (SRS)) or current sensitivity or coverage characteristics. In some cases, the LP-SS and LP-RS and preamble signal type may also change based on the type of LP-WUS. For example, an SSB or CSI-RS or TRS or DMRS like LP-SS/LP-RS/preamble signal may be associated with a PDCCH-based DCI (polar coded) while a sequence based or OOK-based LP-SS or preamble may be associated with a sequence-based or OOK-based LP-WUS.

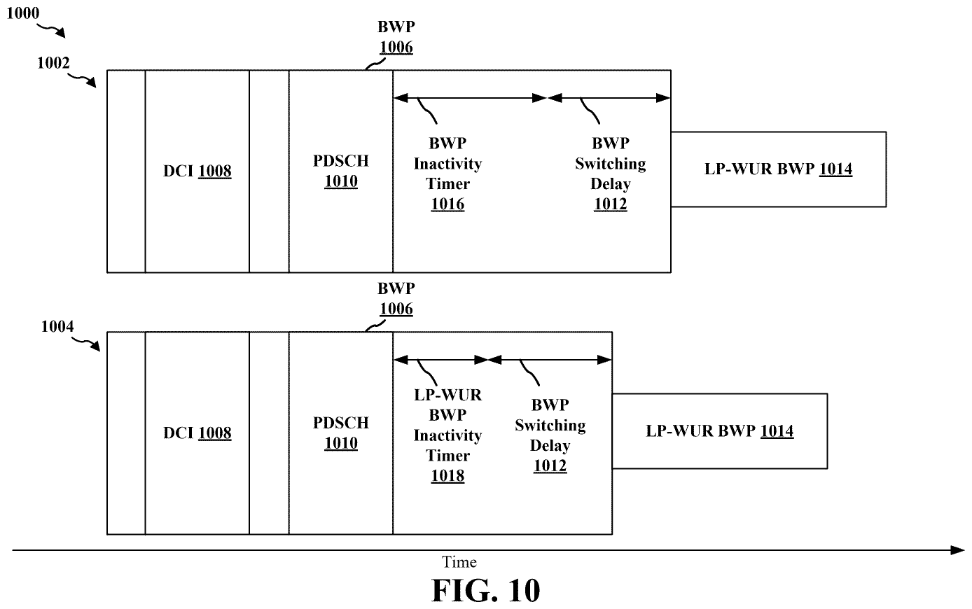

FIG. 10 is a diagram 1000 illustrating example BWPs, LP-WUR BWPs, and timers. The diagram 1000 includes a first example 1002 and a second example 1004. The first example 1002 and the second example 1004 depict a BWP 1006, a DCI 1008, a PDSCH transmission 1010, a BWP switching delay 1012, and a LP-WUR BWP 1014. The BWP 1006 may be the first BWP 702 or the second BWP 704. The DCI 1008 may be the DCI 518. The PDSCH transmission 1010 may be the PDSCH transmission 520. The BWP switching delay 1012 may be the BWP switching delay 522. The LP-WUR BWP 1014 may be the first LP-WUR BWP 706 or the second LP-WUR BWP 708.

In the first example 1002, a UE (e.g., the UE 610) may switch from monitoring the BWP 1006 for data/signals to monitoring the LP-WUR BWP 1014 based on an expiration of a BWP inactivity timer 1016 (e.g., the BWP inactivity timer 524) and the BWP switching delay 1012. Although not depicted in the diagram 1000, the UE may also switch to monitoring another BWP based on the expiration of the BWP inactivity timer 1016 and the BWP switching delay 1012.

In the second example 1004, the UE may switch from monitoring the BWP 1006 for data/signals to monitoring the LP-WUR BWP 1014 based on an expiration of a LP-WUR BWP inactivity timer 1018 and the BWP switching delay 1012. In an example, the LP-WUR BWP inactivity timer 1018 may have a shorter duration compared to a duration of the BWP inactivity timer 1016.

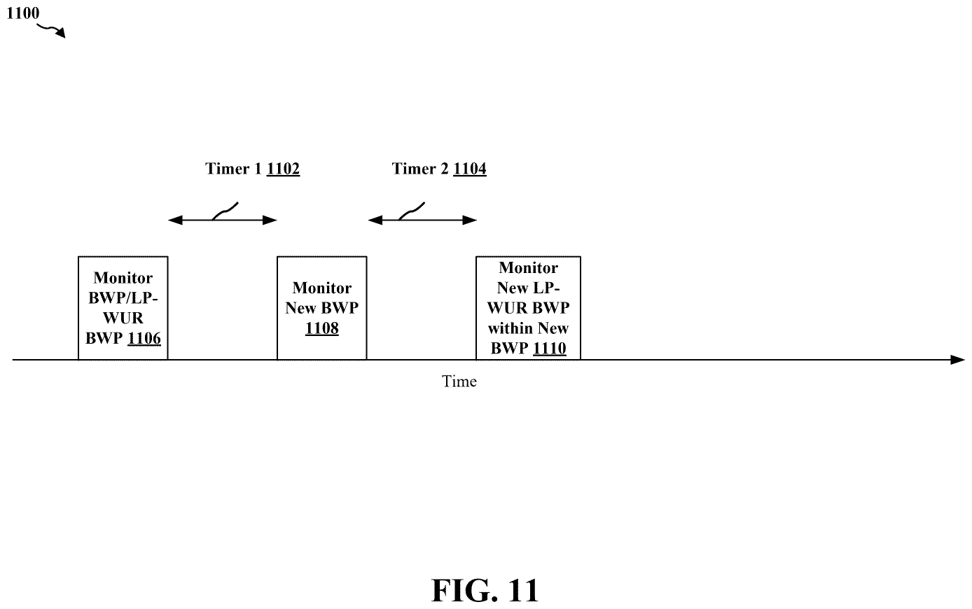

FIG. 11 is a diagram 1100 illustrating an example timeline depicting a UE switching between monitoring BWPs and LP-WUR BWPs based on an expiration of a first timer 1102 and an expiration of a second timer 1104. In an example, the BWP may be the first BWP 702 and the LP-WUR BWP may be the first LP-WUR BWP 706, the new BWP may be the second BWP 704, the new LP-WUR BWP within the new BWP may be the second LP-WUR BWP 708, the main radio may be the main radio 602 of the UE 610, and the LP-WUR may be the LP-WUR 604 of the UE 610. The first timer 1102 and the second timer 1104 may be configured via RRC signaling, medium access control (MAC) control element (MAC-CE) signaling, or a DCI. In an example, the first timer 1102 or the second timer 1104 may be or include a BWP inactivity timer and/or may be associated with a BWP switching delay. The first timer 1102 and the second timer 1104 may be configured based on UE capability (e.g., based on a UE type or a UE class). The first timer 1102 and the second timer 1104 may be defined in a specification.

At 1106, the UE may monitor a BWP via a main radio or the UE may monitor a LP-WUR BWP via a LP-WUR. At 1108, based on an expiration of the first timer 1102, the UE may switch to monitoring a new BWP via the main radio. At 1110, based on an expiration of the second timer 1104, the UE may switch to monitoring a new LP-WUR BWP within the new BWP via the LP-WUR.

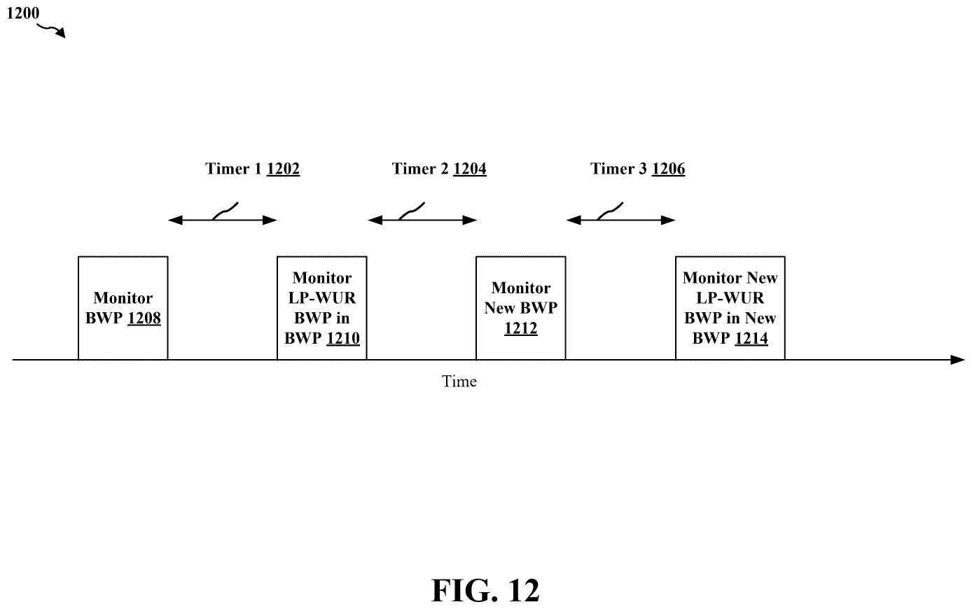

FIG. 12 is a diagram 1200 illustrating an example timeline depicting switching between monitoring BWPs and LP-WUR BWPs based on an expiration of a first timer 1202, a second timer 1204, and a third timer 1206. In an example, the BWP may be the first BWP 702, the LP-WUR BWP in the BWP may be the first LP-WUR BWP 706, the new BWP may be the second BWP 704, the new LP-WUR BWP within the new BWP may be the second LP-WUR BWP 708, the main radio may be the main radio 602 of the UE 610, and the LP-WUR may be the LP-WUR 604 of the UE 610. The first timer 1202, the second timer 1204, and the third timer 1206 may be configured via RRC signaling, MAC-CE signaling, or a DCI. In an example, the first timer 1202, the second timer 1204, and/or the third timer 1206 may be or include a BWP inactivity timer and/or may be associated with a BWP switching delay. The first timer 1202, the second timer 1204, and the third timer 1206 may be configured based on UE capability (e.g., based on a UE type or a UE class). The first timer 1202, the second timer 1204, and the third timer 1206 may be defined in a specification.

At 1208, the UE may monitor a BWP via a main radio of the UE. At 1210, based on an expiration of the first timer 1202, the UE may switch to monitoring a LP-WUR BWP in the BWP. At 1212, based on an expiration of the second timer 1204, the UE may switch to monitoring a new BWP. At 1214, based on an expiration of the third timer 1206, the UE may switch to monitoring a new LP-WUR BWP in the new BWP.

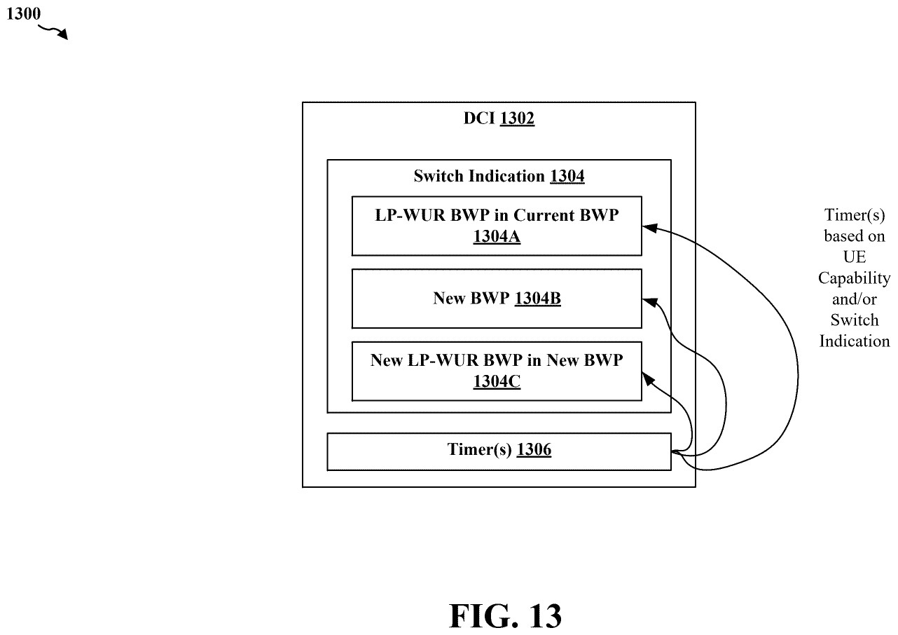

FIG. 13 is a diagram 1300 illustrating an example of a DCI 1302. In an example, the DCI 1302 may be or include the DCI 518 and/or the DCI 1008 described above. The DCI may be transmitted by a base station to a UE (e.g., the UE 104, the UE 350, the UE 610, etc.). The DCI 1302 may include a switch indication 1304 that indicates a BWP/LP-WUR BWP that the UE is to switch to monitoring upon receiving the DCI 1302. In an example, the switch indication 1304 may indicate that the UE is to switch to monitoring a LP-WUR BWP in a current BWP 1304A. In another example, the switch indication 1304 may indicate that the UE is to switch to monitoring a new BWP 1304B (that is different than a current BWP). In another example, the switch indication 1304 may indicate that the UE is to switch to monitoring a new LP-WUR BWP in a new BWP 1304C.

The DCI 1302 may also include indications of one or more timers 1306. In an example, the one or more timers 1306 may include modified values for a BWP switching delay based on UE capability and/or the switch indication 1304 (e.g., whether the switch indication indicates the LP-WUR BWP in a current BWP 1304A, the new BWP 1304B, or the new LP-WUR BWP in the new BWP 1304C). The one or more timers 1306 may include be or include a BWP inactivity timer, a BWP switching delay, or another timer.

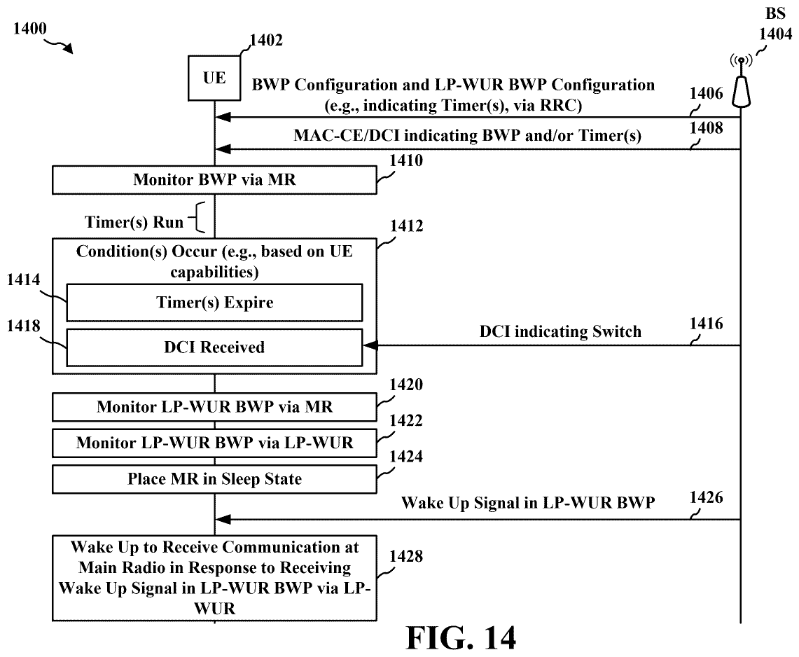

FIG. 14 is a diagram 1400 illustrating example communications between a UE 1402 and a base station 1404. In an example, the UE 1402 may be any of the UEs described herein (e.g., the UE 104, the UE 350, the UE 610, the apparatus 1904). In an example, the base station 1404 may be the base station 102, the base station 310, or the network entity 2002).

At 1406, the UE 1402 may receive a BWP configuration (i.e., a first configuration) and a LP-WUR BWP configuration (i.e., a second configuration) from the base station 1404. The BWP configuration and the LP-WUR BWP configuration may be received separately or concurrently via RRC signaling. The BWP configuration may be or include the main radio configuration 902 and the LP-WUR BWP configuration may be or include the LP-WUR configuration 904. The BWP configuration and/or the LP-WUR BWP configuration may include indication(s) of timer(s). In an example, the timer(s) may be or include the BWP inactivity timer 1016, the LP-WUR BWP inactivity timer 1018, the first timer 1102 and the second timer 1104 described in the description of FIG. 11, the first timer 1202, the second timer 1204, and the third timer 1206 described in the description of FIG. 12, or another timer. The timer(s) may also include the BWP switching delay 522 or the BWP switching delay 1012. In one aspect, at 1408, the UE 1402 may receive a MAC-CE or a DCI that includes the indication(s) of the timer(s) described above. In an example, the DCI may be the DCI 1302 or the DCI may include aspects described above in the description of the DCI 1302. In an example, the UE 1402 may cause one or more timers to begin to run based on the BWP configuration, the LP-WUR BWP configuration, and/or the MAC-CE/DCI.

At 1410, the UE 1402 may monitor a BWP via a main radio of the UE 1402. In an example, the main radio may be the main radio 602. The BWP may be indicated/defined in the BWP configuration received at 1406 or indicated by the MAC-CE/DCI received at 1408.

At 1412, the UE 1402 may detect that one or more conditions have occurred. In one example, at 1414, the UE 1402 may detect that the one or more timers have expired. In another example, at 1416, the base station 1404 may transmit a DCI indicating a BWP/LP-WUR BWP switch. In an example, the DCI may be the DCI 1302. In the example, at 1418, the UE 1402 may detect that the DCI (transmitted at 1416) has been received.

At 1420, based on the condition(s) occurring, the UE 1402 may monitor a LP-WUR BWP via the main radio. At 1422, the UE 1402 may monitor the LP-WUR BWP via a LP-WUR of the UE 1402. At 1424, subsequent to or concurrently with monitoring the LP-WUR BWP via the LP-WUR, the UE may place the main radio in a sleep state.

At 1426, the UE 1402 may receive a wake up signal (e.g., a LP-WUS) in the LP-WUR BWP via the LP-WUR. At 1428, in response to receiving the wake up signal, the UE 1402 may wake up to receive communication at the main radio.

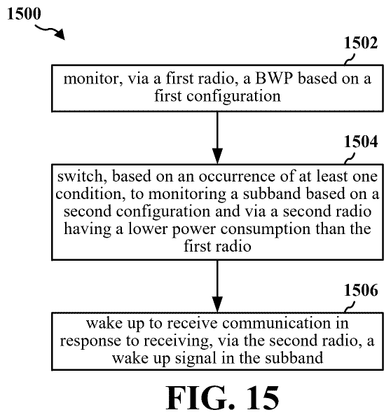

FIG. 15 is a flowchart 1500 of a method of wireless communication. The method may be performed by a UE (e.g., the UE 104, the UE 350, the UE 1402, the apparatus 1904). The method may be associated with various advantages at the UE, such as lower power consumption, lower latency, and/or reduced RF tuning and retuning via usage of the same antenna(s) and re-usage of channel characteristics. In an example, the method may be performed by the LP wake up component 198.

At 1502, the UE monitors, via a first radio, a BWP based on a first configuration. For example, FIG. 14 at 1410 shows that the UE 1402 may monitor a BWP via a main radio. In another example, FIG. 8 at 802 shows that a main radio of a UE may monitor a BWP. In a further example, the first radio may be the main radio 602. In an example, the BWP may be the first BWP 702 or the second BWP 704. In yet another example, the first configuration may be or include the main radio configuration 902. In an example, 1502 may be performed by the LP wake up component 198.

At 1504, the UE switches, based on an occurrence of at least one condition, to monitoring a subband based on a second configuration and via a second radio having a lower power consumption than the first radio. For example, FIG. 14 at 1412 shows that the UE 1402 may detect that one or more conditions occur and FIG. 14 at 1422 shows that the UE 1402 may monitor a LP-WUR BWP (i.e., a subband) based on the one or more conditions occurring. In another example, FIG. 8 at 808 shows that a LP-WUR of a UE may monitor a LP-WUR BWP (i.e., a subband). In another example, the second radio may be the LP-WUR 604 and the LP-WUR 604 may have a lower power consumption than the main radio 602 (i.e., a first radio). In a further example, the second configuration may be the LP-WUR configuration 904. In yet another example, the subband may be the first LP-WUR BWP 706 or the second LP-WUR BWP 708. In an example, 1504 may be performed by the LP wake up component 198.

At 1506, the UE wakes up to receive communication in response to receiving, via the second radio, a wake up signal in the subband. For example, FIG. 14 at 1428 shows that the UE 1402 may wake up to receive communication in response to receiving a wake up signal in a LP-WUR BWP via a LP-WUR. In another example, FIG. 8 at 812 and 814 show that a UE may wake up in response to receiving a wake up signal at a LP-WUR. In an example, the wake up signal may be the wake up signal 612. In an example, 1506 may be performed by the LP wake up component 198.

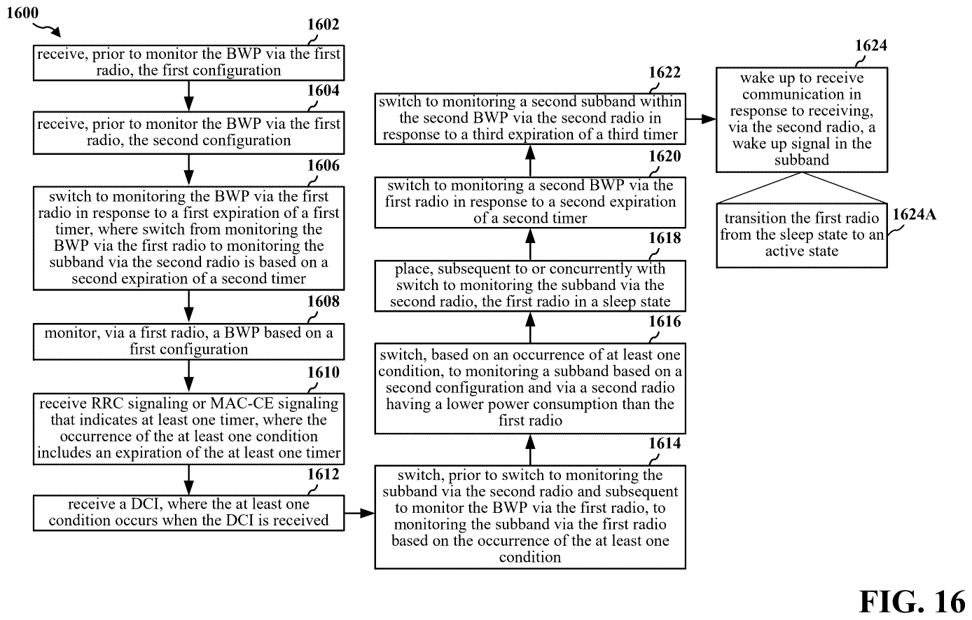

FIG. 16 is a flowchart 1600 of a method of wireless communication. The method may be performed by a UE (e.g., the UE 104, the UE 350, the UE 1402, the apparatus 1904). The method may be associated with various advantages at the UE, such as lower power consumption, lower latency, and/or reduced RF tuning and retuning via usage of the same antenna(s) and re-usage of channel characteristics. In an example, the method (including the various aspects described below) may be performed by the LP wake up component 198.

At 1608, the UE monitors, via a first radio, a BWP based on a first configuration. For example, FIG. 14 at 1410 shows that the UE 1402 may monitor a BWP via a main radio. In another example, FIG. 8 at 802 shows that a main radio of a UE may monitor a BWP. In a further example, the first radio may be the main radio 602. In an example, the BWP may be the first BWP 702 or the second BWP 704. In yet another example, the first configuration may be or include the main radio configuration 902. In an example, 1608 may be performed by the LP wake up component 198.

At 1616, the UE switches, based on an occurrence of at least one condition, to monitoring a subband based on a second configuration and via a second radio having a lower power consumption than the first radio. For example, FIG. 14 at 1412 shows that the UE 1402 may detect that one or more conditions occur and FIG. 14 at 1422 shows that the UE 1402 may monitor a LP-WUR BWP (i.e., a subband) based on the one or more conditions occurring. In another example, FIG. 8 at 808 shows that a LP-WUR of a UE may monitor a LP-WUR BWP (i.e., a subband). In another example, the second radio may be the LP-WUR 604 and the LP-WUR 604 may have a lower power consumption than the main radio 602 (i.e., a first radio). In a further example, the second configuration may be the LP-WUR configuration 904. In yet another example, the subband may be the first LP-WUR BWP 706 or the second LP-WUR BWP 708. In an example, 1616 may be performed by the LP wake up component 198.

At 1624, the UE wakes up to receive communication in response to receiving, via the second radio, a wake up signal in the subband. For example, FIG. 14 at 1428 shows that the UE 1402 may wake up to receive communication in response to receiving a wake up signal in a LP-WUR BWP via a LP-WUR. In another example, FIG. 8 at 812 and 814 show that a UE may wake up in response to receiving a wake up signal at a LP-WUR. In an example, the wake up signal may be the wake up signal 612. In an example, 1624 may be performed by the LP wake up component 198.

In one aspect, the occurrence of the at least one condition may include an expiration of a BWP inactivity timer. For example, FIG. 14 at 1414 shows that the one or more conditions occurring may include one or more timers expiring. In another example, the BWP inactivity timer may be the BWP inactivity timer 524 or the BWP inactivity timer 1016.

In one aspect, the occurrence of the at least one condition may include an expiration of a timer, where the timer is different than a BWP inactivity timer. For example, FIG. 14 at 1414 shows that the one or more conditions occurring may include one or more timers expiring. In another example, the timer may be the BWP switching delay 522, the LP-WUR BWP inactivity timer 1018, the BWP switching delay 1012, the first timer 1102, the second timer 1104, the first timer 1202, the second timer 1204, or the third timer 1206.

In one aspect, the timer may be associated with a first duration and the BWP inactivity timer may be associated with a second duration, where the first duration is less than the second duration. For example, FIG. 10 shows that the LP-WUR BWP inactivity timer 1018 may have a first duration and the BWP inactivity timer 1016 may have a second duration, where the first duration is less than the second duration.

In one aspect, the subband may be within the BWP. For example, the subband may be the first LP-WUR BWP 706 and the BWP may be the first BWP 702 and FIG. 7 shows that the first LP-WUR BWP 706 may be within the first BWP 702.

In one aspect, the subband may be within a first BWP that is different than the BWP. For example, the subband may be the first LP-WUR BWP 706, the first BWP may be the first BWP 702, and the BWP may be the second BWP 704.

In one aspect, at 1614, the UE may switch, prior to switch to monitoring the subband via the second radio and subsequent to monitor the BWP via the first radio, to monitoring the subband via the first radio based on the occurrence of the at least one condition. For example, FIG. 14 at 1420 shows that the UE 1402 may monitor a LP-WUR BWP (i.e., a subband) via a main radio upon one or more conditions occurring at 1412. In another example, FIG. 8 at 806 shows that a main radio of a UE may monitor a LP-WUR BWP subsequent to a condition occurring at 804 and prior to a LP-WUR of the UE monitoring the LP-WUR BWP at 808. In an example, 1614 may be performed by the LP wake up component 198.

In one aspect, at 1618, the UE may place, subsequent to or concurrently with switch to monitoring the subband via the second radio, the first radio in a sleep state. For example, FIG. 14 at 1424 shows that the UE 1402 may place a main radio in a sleep state. In another example, FIG. 8 at 810 shows that a UE may place a main radio in a sleep state. In an example, 1618 may be performed by the LP wake up component 198.

In one aspect, at 1624A, waking up to receive the communication includes transitioning the first radio from the sleep state to an active state. For example, the timelines 608 show that a UE may place a main radio into an active state in response to receiving a wake up signal 612. In another example, FIG. 8 at 814 shows that a UE may wake up a main radio of the UE from a sleep state. In an example, 1624A may be performed by the LP wake up component 198.

In one aspect, at 1602, the UE may receive, prior to monitor the BWP via the first radio, the first configuration. For example, FIG. 14 at 1406 shows that the UE 1402 may receive a BWP configuration (i.e., a first configuration). In another example, the first configuration may be the main radio configuration 902. In an example, 1602 may be performed by the LP wake up component 198.

In one aspect, at 1604, the UE may receive, prior to monitor the BWP via the first radio, the second configuration. For example, FIG. 14 at 1406 shows that the UE 1402 may receive a LP-WUR BWP configuration (i.e., a second configuration). In another example, the second configuration may be the LP-WUR configuration 904. In an example, 1604 may be performed by the LP wake up component 198.

In one aspect, the first configuration may include first one or more parameters and the second configuration may include second one or more parameters, where at least one of the second one or more parameters may be inherited from the first one or more parameters, where the first configuration and the second configuration are based on UE reported capabilities. For example, the first one or more parameters may be the main radio parameters 916 and the second one or more parameters may be the LP-WUR parameters 926. Furthermore, FIG. 9 shows that at least one of the LP-WUR parameters 926 may be inherited from the main radio parameters 916.

In one aspect, at least one of the first one or more parameters or the second one or more parameters may indicate one or more of: first characteristics of wake up monitoring occasions of the second radio, second characteristics of reference signals of the second radio, third characteristics of synchronization signals of the second radio, fourth characteristics of wake up signals of the second radio, fifth characteristics of preamble signals associated with the wake up signals, sixth characteristics associated with PDCCH transmission, seventh characteristics associated with CSI or CSI-RS, eighth characteristics associated with SRS, or ninth characteristics associated with at least one of transmission or reception of data. For example, the main radio parameters 916 and/or the LP-WUR parameters 926 may indicate the first characteristics, the second characteristics, the third characteristics, the fourth characteristics, the fifth characteristics, the sixth characteristics, the seventh characteristics, the eighth characteristics, and/or the ninth characteristics.

In one aspect, a preamble is used for synchronization, where the preamble is associated with at least a first periodicity and a first bandwidth that is different from or equivalent to a second periodicity and a second bandwidth associated with the wake up signal, where a length and a configuration of the preamble is different across different instances of wake up signals and is based in part on a low-power synchronization signal configuration or a low-power synchronization signal timing. In an example, the preamble may be the preamble 614. In another example, FIG. 6 shows that the preamble 614 may have a different periodicity than a periodicity of the wake up signal 612. In some aspects, the preamble size/length and configuration may be different from one wakeup occasion to another. In some examples, based on LP-SS configuration and LP-WUS configuration, the preamble may be associated with a WUS closer in time to LP-SS that may have smaller size/length than preamble signals associated with WUS signals far in time from LP-SS signal. In some examples, this may be because the LP-SS may be used for synchronization (and may fix timing and frequency tracking errors due to clock drift) and may be an always present signal or an almost always present signal (e.g., similar to SSB used to sync a main radio) and, hence, a LP-WUS occasion nearby a LP-SS may be associated with a smaller size/length preamble (since most timing and frequency misalignment or out-of-sync issues may be fixed or adjusted by an LP-SS occasion occurring before a LP-WUS occasion). The length of each preamble associated with each WUS may increase as time progresses far from a LP-SS occasion/time.

In one aspect, at 1612, the UE may receive a DCI, where the at least one condition may occur when the DCI is received. For example, FIG. 14 at 1418 shows that the one or more conditions may include the UE 1402 receiving a DCI. In another example, the DCI may be the DCI 518, the DCI 1008, and/or the DCI 1302. In an example, 1612 may be performed by the LP wake up component 198.

In one aspect, the DCI may indicate one or more of: at least one timer, the subband, a different BWP, or the subband within the different BWP. For example, FIG. 13 shows that the DCI 1302 may indicate one or more timers 1306, a LP-WUR BWP in a current BWP 1304A, a new BWP 1304B, or a new LP-WUR BWP in a new BWP 1304C.

In one aspect, at 1606, the subband may be within the BWP and the UE may switch to monitoring the BWP via the first radio in response to a first expiration of a first timer, where switch from monitoring the BWP via the first radio to monitoring the subband via the second radio is based on a second expiration of a second timer. For example, FIG. 11 illustrates the aforementioned aspects. In an example, 1606 may be performed by the LP wake up component 198.

In one aspect, at 1620, the subband may be within the BWP, where the occurrence of the at least one condition may include a first expiration of a first timer and the UE may switch to monitoring a second BWP via the first radio in response to a second expiration of a second timer. For example, FIG. 12 illustrates the aforementioned aspects. In an example, 1620 may be performed by the LP wake up component 198.

In one aspect, at 1622, the UE may switch to monitoring a second subband within the second BWP via the second radio in response to a third expiration of a third timer. For example, FIG. 12 illustrates the aforementioned aspects. In an example, 1622 may be performed by the LP wake up component 198.

In one aspect, at 1610, the UE may receive RRC signaling or MAC-CE signaling that indicates at least one timer, where the occurrence of the at least one condition may include an expiration of the at least one timer. For example, FIG. 14 at 1406 and 1408 shows that the UE 1402 may receive RRC signaling and/or MAC-CE signaling that indicates one or more timers. In another example, FIG. 14 at 1412 shows that an occurrence of a condition may include a timer expiring. In an example, 1610 may be performed by the LP wake up component 198.

In one aspect, the at least one condition may be based on capabilities of the UE. For example, FIG. 14 at 1412 shows that one or more conditions may be based on UE capabilities.

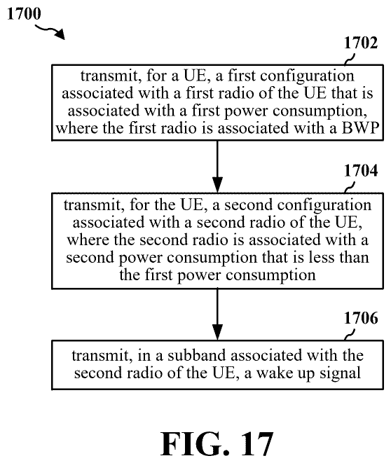

FIG. 17 is a flowchart 1700 of a method of wireless communication. The method may be performed by a network node (e.g., the base station 102, the base station 310, the base station 1404, the network entity 2002). The method may be associated with various advantages at the network node, such as increased communications reliability with UEs. In an example, the method may be performed by the LP wake up component 199.

At 1702, the network node transmits, for a UE, a first configuration associated with a first radio of the UE that is associated with a first power consumption, where the first radio is associated with a BWP. For example, FIG. 14 at 1406 shows that the base station 1404 may transmit a BWP configuration (i.e., a first configuration) for the UE 1402. In another example, the first configuration may be the main radio configuration 902. In another example, the first radio may be the main radio 602. In an example, the BWP may be the first BWP 702 or the second BWP 704. In an example, 1702 may be performed by the LP wake up component 199.

At 1704, the network node transmits, for the UE, a second configuration associated with a second radio of the UE, where the second radio is associated with a second power consumption that is less than the first power consumption. For example, FIG. 14 at 1406 shows that the base station 1404 may transmit a LP-WUR BWP configuration (i.e., a second configuration) for the UE 1402. In another example, the second configuration may be the LP-WUR configuration 904. In another example, the second radio may be the LP-WUR 604. In an example, 1704 may be performed by the LP wake up component 199.

At 1706, the network node transmits, in a subband associated with the second radio of the UE, a wake up signal. For example, FIG. 14 at 1426 shows that the base station 1404 may transmit a wake up signal in a LP-WUR BWP (i.e., a subband). In another example, the wake up signal may be the wake up signal 612. In a further example, the subband may be the first LP-WUR BWP 706 or the second LP-WUR BWP 708. In an example, 1706 may be performed by the LP wake up component 199.

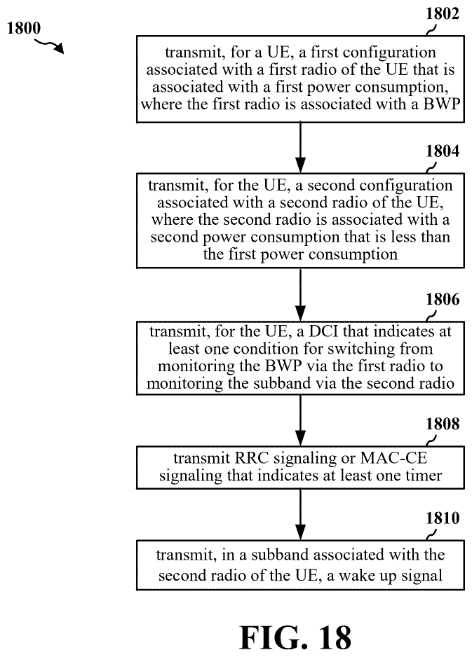

FIG. 18 is a flowchart 1800 of a method of wireless communication. The method may be performed by a base station (e.g., the base station 102, the base station 310, the base station 1404, the network entity 2002). The method may be associated with various advantages at the base station, such as increased communications reliability with UEs. In an example, the method (including the various aspects described below) may be performed by the LP wake up component 199.

At 1802, the network node transmits, for a UE, a first configuration associated with a first radio of the UE that is associated with a first power consumption, where the first radio is associated with a BWP. For example, FIG. 14 at 1406 shows that the base station 1404 may transmit a BWP configuration (i.e., a first configuration) for the UE 1402. In another example, the first configuration may be the main radio configuration 902. In another example, the first radio may be the main radio 602. In an example, the BWP may be the first BWP 702 or the second BWP 704. In an example, 1802 may be performed by the LP wake up component 199.

At 1804, the network node transmits, for the UE, a second configuration associated with a second radio of the UE, where the second radio is associated with a second power consumption that is less than the first power consumption. For example, FIG. 14 at 1406 shows that the base station 1404 may transmit a LP-WUR BWP configuration (i.e., a second configuration) for the UE 1402. In another example, the second configuration may be the LP-WUR configuration 904. In another example, the second radio may be the LP-WUR 604. In an example, 1804 may be performed by the LP wake up component 199.

At 1810, the network node transmits, in a subband associated with the second radio of the UE, a wake up signal. For example, FIG. 14 at 1426 shows that the base station 1404 may transmit a wake up signal in a LP-WUR BWP (i.e., a subband). In another example, the wake up signal may be the wake up signal 612. In a further example, the subband may be the first LP-WUR BWP 706 or the second LP-WUR BWP 708. In an example, 1810 may be performed by the LP wake up component 199.

In one aspect, the subband may be within the BWP. For example, the subband may be the first LP-WUR BWP 706 and the BWP may be the first BWP 702 and FIG. 7 shows that the first LP-WUR BWP 706 may be within the first BWP 702.

In one aspect, the subband may be within a first BWP that is different than the BWP. For example, the subband may be the first LP-WUR BWP 706, the first BWP may be the first BWP 702, and the BWP may be the second BWP 704.

In one aspect, at 1806, the network node may transmit, for the UE, a DCI that indicates at least one condition for switching from monitoring the BWP via the first radio to monitoring the subband via the second radio. For example, FIG. 14 at 1416 shows that the base station 1404 may transmit a DCI for the UE 1402, where the DCI may indicate a condition for switching from monitoring the BWP via the first radio to monitoring the subband via the second radio. In an example, the DCI may be the DCI 518, the DCI 1008, or the DCI 1302. In an example, 1806 may be performed by the LP wake up component 199.

In one aspect, the at least one condition may include at least one of: an expiration of at least one timer, or reception of the DCI. For example, FIG. 14 at 1412 shows that one or more conditions may include one or more timers expiring and/or a DCI being received.

In one aspect, the first configuration may include first one or more parameters and the second configuration may include second one or more parameters, where at least one of the second one or more parameters may be inherited from the first one or more parameters, where the first configuration and the second configuration are based on UE reported capabilities. For example, the first one or more parameters may be the main radio parameters 916 and the second one or more parameters may be the LP-WUR parameters 926. Furthermore, FIG. 9 shows that at least one of the LP-WUR parameters 926 may be inherited from the main radio parameters 916.

In one aspect, at least one of the first one or more parameters or the second one or more parameters may indicate one or more of: first characteristics of wake up monitoring occasions of the second radio, second characteristics of reference signals of the second radio, third characteristics of synchronization signals of the second radio, fourth characteristics of wake up signals of the second radio, fifth characteristics of preamble signals associated with the wake up signals, sixth characteristics associated with PDCCH transmission, seventh characteristics associated with CSI or CSI-RS, eighth characteristics associated with SRS, or ninth characteristics associated with at least one of transmission or reception of data. For example, the main radio parameters 916 and/or the LP-WUR parameters 926 may indicate the first characteristics, the second characteristics, the third characteristics, the fourth characteristics, the fifth characteristics, the sixth characteristics, the seventh characteristics, the eighth characteristics, and/or the ninth characteristics.

In one aspect, at 1808, the network node may transmit RRC signaling or MAC-CE signaling that indicates at least one timer. For example, FIG. 14 at 1406 shows that the base station 1404 may transmit RRC signaling and/or MAC-CE signaling that indicates one or more timers. In an example, 1808 may be performed by the LP wake up component 199.

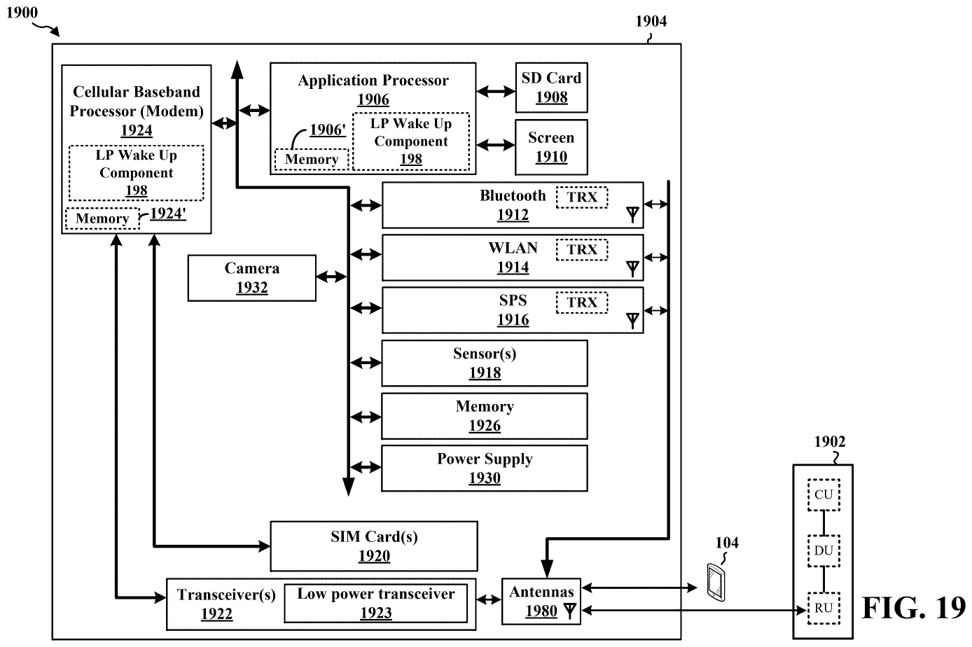

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver), which may include a transceiver 1923 with a lower power consumption than one or more other transceivers. The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the LP wake up component 198 is configured to monitor, via a first radio, a BWP based on a first configuration. The LP wake up component 198 is configured to switch, based on an occurrence of at least one condition, to monitoring a subband based on a second configuration and via a second radio having a lower power consumption than the first radio. The LP wake up component 198 is configured to wake up to receive communication in response to receiving, via the second radio, a wake up signal in the subband. The LP wake up component 198 is configured to switch, prior to switch to monitoring the subband via the second radio and subsequent to monitor the BWP via the first radio, to monitoring the subband via the first radio based on the occurrence of the at least one condition. The LP wake up component 198 is configured to place, subsequent to or concurrently with switch to monitoring the subband via the second radio, the first radio in a sleep state. The LP wake up component 198 is configured to transition the first radio from the sleep state to an active state. The LP wake up component 198 is configured to receive, prior to monitor the BWP via the first radio, the first configuration. The LP wake up component 198 is configured to receive, prior to monitor the BWP via the first radio, the second configuration. The LP wake up component 198 is configured to receive a DCI, where the at least one condition occurs when the DCI is received. The LP wake up component 198 is configured to switch to monitoring the BWP via the first radio in response to a first expiration of a first timer, where switch from monitoring the BWP via the first radio to monitoring the subband via the second radio is based on a second expiration of a second. The LP wake up component 198 is configured to switch to monitoring a second BWP via the first radio in response to a second expiration of a second timer. The LP wake up component 198 is configured to switch to monitoring a second subband within the second BWP via the second radio in response to a third expiration of a third timer. The LP wake up component 198 is configured to receive RRC signaling or MAC-CE signaling that indicates at least one timer, where the occurrence of the at least one condition includes an expiration of the at least one timer. The LP wake up component 198 may be within the cellular baseband processor 1924, the application processor 1906, or both the cellular baseband processor 1924 and the application processor 1906. The LP wake up component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for monitoring, via a first radio, a BWP based on a first configuration. In one configuration, the apparatus 1904, and in particular the cellular baseband processor 1924 and/or the application processor 1906, includes means for switching, based on an occurrence of at least one condition, to monitoring a subband based on a second configuration and via a second radio having a lower power consumption than the first radio. In one configuration, the apparatus 1904, and in particular the cellular baseband processor 1924 and/or the application processor 1906, includes means for waking up to receive communication in response to receiving, via the second radio, a wake up signal in the subband. In one configuration, the apparatus 1904, and in particular the cellular baseband processor 1924 and/or the application processor 1906, includes means for switching, prior to switching to monitoring the subband via the second radio and subsequent to monitoring the BWP via the first radio, to monitoring the subband via the first radio based on the occurrence of the at least one condition. In one configuration, the apparatus 1904, and in particular the cellular baseband processor 1924 and/or the application processor 1906, includes means for placing, subsequent to or concurrently with switching to monitoring the subband via the second radio, the first radio in a sleep state. In one configuration, the apparatus 1904, and in particular the cellular baseband processor 1924 and/or the application processor 1906, includes means for transitioning the first radio from the sleep state to an active state. In one configuration, the apparatus 1904, and in particular the cellular baseband processor 1924 and/or the application processor 1906, includes means for receiving, prior to monitoring the BWP via the first radio, the first configuration. In one configuration, the apparatus 1904, and in particular the cellular baseband processor 1924 and/or the application processor 1906, includes means for receiving, prior to monitoring the BWP via the first radio, the second configuration. In one configuration, the apparatus 1904, and in particular the cellular baseband processor 1924 and/or the application processor 1906, includes means for receiving a DCI, where the at least one condition occurs when the DCI is received. In one configuration, the apparatus 1904, and in particular the cellular baseband processor 1924 and/or the application processor 1906, includes means for switching to monitoring the BWP via the first radio in response to a first timer expiring, where switching from monitoring the BWP via the first radio to monitoring the subband via the second radio is based on a second timer expiring. In one configuration, the apparatus 1904, and in particular the cellular baseband processor 1924 and/or the application processor 1906, includes means for switching to monitoring a second BWP via the first radio in response to a second timer expiring. In one configuration, the apparatus 1904, and in particular the cellular baseband processor 1924 and/or the application processor 1906, includes means for switching to monitoring a second subband within the second BWP via the second radio in response to a third timer expiring. In one configuration, the apparatus 1904, and in particular the cellular baseband processor 1924 and/or the application processor 1906, includes means for receiving RRC signaling or MAC-CE signaling that indicates at least one timer, where the occurrence of the at least one condition includes the at least one timer expiring. The means may be the LP wake up component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

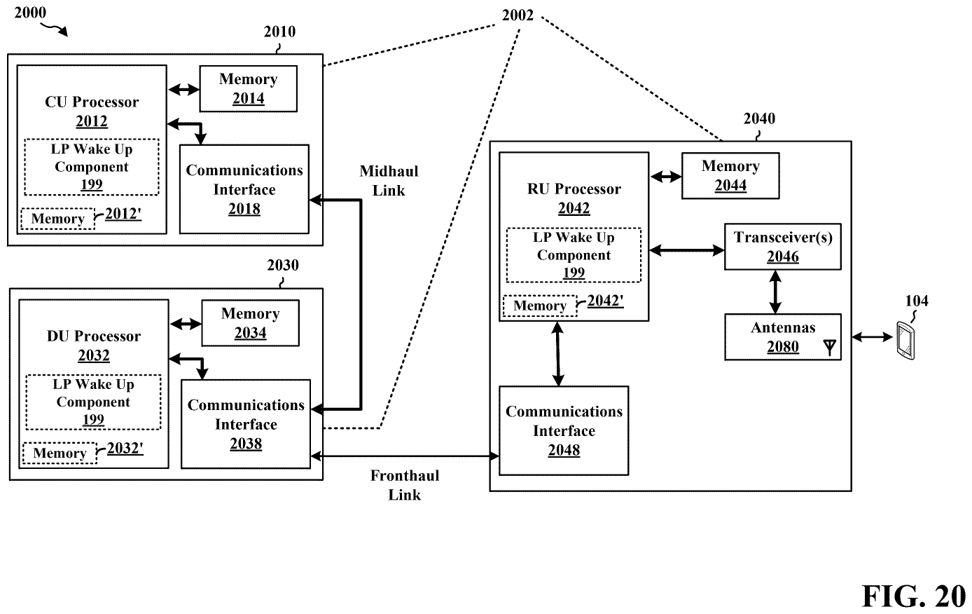

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the LP wake up component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the LP wake up component 199 is configured to transmit, for a UE, a first configuration associated with a first radio of the UE that is associated with a first power consumption, where the first radio is associated with a BWP. The LP wake up component 199 is configured to transmit, for the UE, a second configuration associated with a second radio of the UE, where the second radio is associated with a second power consumption that is less than the first power consumption. The LP wake up component 199 is configured to transmit, in a subband associated with the second radio of the UE, a wake up signal. The LP wake up component 199 is configured to transmit, for the UE, a DCI that indicates at least one condition for switching from monitoring the BWP via the first radio to monitoring the subband via the second radio. The LP wake up component 199 is configured to transmit RRC signaling or MAC-CE signaling that indicates at least one timer. The LP wake up component 199 may be within one or more processors of one or more of the CU 2010, DU 2030, and the RU 2040. The LP wake up component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for transmitting, for a UE, a first configuration associated with a first radio of the UE that is associated with a first power consumption, where the first radio is associated with a BWP. In one configuration, the network entity 2002 includes means for transmitting, for the UE, a second configuration associated with a second radio of the UE, where the second radio is associated with a second power consumption that is less than the first power consumption. In one configuration, the network entity 2002 includes means for transmitting, in a subband associated with the second radio of the UE, a wake up signal. In one configuration, the network entity 2002 includes means for transmitting, for the UE, a DCI that indicates at least one condition for switching from monitoring the BWP via the first radio to monitoring the subband via the second radio. In one configuration, the network entity 2002 includes means for transmitting RRC signaling or MAC-CE signaling that indicates at least one timer. The means may be the LP wake up component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

As noted above, a UE may be configured with a main radio and a LP-WUR, where the main radio may be associated with a higher power consumption than the LP-WUR. The UE may place the main radio in a sleep state and may monitor for a wake up signal in a BWP via the LP-WUR. However, monitoring a BWP for a wake up signal may consume power. Furthermore, if the wake up signal is to be received in a different BWP than a current BWP, the UE may have to perform a BWP switch, which may involve radio frequency tuning, using different antennas, and/or ascertaining channel characteristics associated with the different BWP. Various technologies pertaining to BWPs and LP-WUR BWPs are disclosed herein. In an example, a UE monitors, via a first radio, a BWP based on a first configuration. The UE switches, based on an occurrence of at least one condition, to monitoring a subband based on a second configuration and via a second radio having a lower power consumption than the first radio. The UE wakes up to receive communication in response to receiving, via the second radio, a wake up signal in the subband. Vis-à-vis switching to monitoring the subband via the second radio (i.e., a LP-WUR), the UE may consume less power in comparison to monitoring a BWP. Furthermore, vis-à-vis monitoring the subband, the UE may avoid BWP switching, avoid radio frequency tuning or retuning, and may reuse antennas and/or channel characteristics.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), including: monitoring, via a first radio, a bandwidth part (BWP) based on a first configuration; switching, based on an occurrence of at least one condition, to monitoring a subband based on a second configuration and via a second radio having a lower power consumption than the first radio; and waking up to receive communication in response to receiving, via the second radio, a wake up signal in the subband.

Aspect 2 is the method of aspect 1, where the occurrence of the at least one condition includes a BWP inactivity timer expiring.

Aspect 3 is the method of any of aspects 1-2, where the occurrence of the at least one condition includes a timer expiring, where the timer is different than a BWP inactivity timer.

Aspect 4 is the method of aspect 3, where the timer is associated with a first duration and the BWP inactivity timer is associated with a second duration, where the first duration is less than the second duration.

Aspect 5 is the method of any of aspects 1-4, where the subband is within the BWP.

Aspect 6 is the method of any of aspects 1-4, where the subband is within a first BWP that is different than the BWP.

Aspect 7 is the method of any of aspects 1-6, further including: switching, prior to switching to monitoring the subband via the second radio and subsequent to monitoring the BWP via the first radio, to monitoring the subband via the first radio.

Aspect 8 is the method of aspect 7, further including: placing, subsequent to or concurrently with switching to monitoring the subband via the second radio, the first radio in a sleep state.

Aspect 9 is the method of aspect 8, where waking up to receiving the communication includes transitioning the first radio from the sleep state to an active state.

Aspect 10 is the method of any of aspects 1-9, further including: receiving, prior to monitoring the BWP via the first radio, the first configuration; and receiving, prior to monitoring the BWP via the first radio, the second configuration.

Aspect 11 is the method of aspect 10, where the first configuration includes first one or more parameters and the second configuration includes second one or more parameters, where at least one of the second one or more parameters are inherited from the first one or more parameters, where the first configuration and the second configuration are based on UE reported capabilities.

Aspect 12 is the method of aspect 11, where at least one of the first one or more parameters or the second one or more parameters indicate one or more of: first characteristics of wake up monitoring occasions of the second radio, second characteristics of reference signals of the second radio, third characteristics of synchronization signals of the second radio, fourth characteristics of wake up signals of the second radio, fifth characteristics of preamble signals associated with the wake up signals, sixth characteristics associated with physical downlink control channel (PDCCH) transmission, seventh characteristics associated with channel state information (CSI) or channel state information reference signals (CSI-RS), eighth characteristics associated with sounding reference signals (SRS), or ninth characteristics associated with at least one of transmission or reception of data.

Aspect 13 is the method of any of aspects 1-12, where a preamble is used for synchronization, where the preamble is associated with at least a first periodicity and a first bandwidth that is different from or equivalent to a second periodicity and a second bandwidth associated with the wake up signal, where a length and a configuration of the preamble is different across different instances of wake up signals and is based in part on a low-power synchronization signal configuration or a low-power synchronization signal timing.

Aspect 14 is the method of any of aspects 1-13, further including: receiving a downlink control information (DCI), where the at least one condition occurs when the DCI is received.

Aspect 15 is the method of aspect 14, where the DCI indicates one or more of: at least one timer, the subband, a different BWP, or the subband within the different BWP.

Aspect 16 is the method of any of aspects 1-15, where the subband is within the BWP, the method further including: switching to monitoring the BWP via the first radio in response to a first timer expiring, where switching from monitoring the BWP via the first radio to monitoring the subband via the second radio is based on a second timer expiring.

Aspect 17 is the method of any of aspects 1-15, where the subband is within the BWP, where the occurrence of the at least one condition includes a first timer expiring, further including: switching to monitoring a second BWP via the first radio in response to a second timer expiring; and switching to monitoring a second subband within the second BWP via the second radio in response to a third timer expiring.

Aspect 18 is the method of any of aspects 1-17, further including: receiving radio resource control (RRC) signaling or medium access control (MAC) control element (MAC-CE) signaling that indicates at least one timer, where the occurrence of the at least one condition includes the at least one timer expiring.

Aspect 19 is the method of any of aspects 1-18, where the at least one condition is based on capabilities of the UE.

Aspect 20 is an apparatus for wireless communication at a UE including a memory and at least one processor coupled to the memory and based at least in part on information stored in the memory, the at least one processor is configured to perform a method in accordance with any of aspects 1-19.

Aspect 21 is an apparatus for wireless communications, including means for performing a method in accordance with any of aspects 1-19.

Aspect 22 is the apparatus of aspect 20 or 21 further including the first radio and the second radio, where the at least one processor is coupled to the first radio and the second radio.

Aspect 23 is a computer-readable medium (e.g., a non-transitory computer-readable medium) including instructions that, when executed by an apparatus, cause the apparatus to perform a method in accordance with any of aspects 1-19.

Aspect 24 is a method of wireless communication at a network node, including: transmitting, for a user equipment (UE), a first configuration associated with a first radio of the UE that is associated with a first power consumption, where the first radio is associated with a bandwidth part (BWP); transmitting, for the UE, a second configuration associated with a second radio of the UE, where the second radio is associated with a second power consumption that is less than the first power consumption; and transmitting, in a subband associated with the second radio of the UE, a wake up signal.

Aspect 25 is the method of aspect 24, where the subband is within the BWP.

Aspect 26 is the method of aspect 24, where the subband is within a first BWP that is different than the BWP.

Aspect 27 is the method of any of aspects 24-26, further including: transmitting, for the UE, a downlink control information (DCI) that indicates at least one condition for switching from monitoring the BWP via the first radio to monitoring the subband via the second radio.

Aspect 28 is the method of aspect 27, where the at least one condition includes at least one of: at least one timer expiring, or reception of the DCI.

Aspect 29 is the method of any of aspects 24-28, where the first configuration includes first one or more parameters and the second configuration includes second one or more parameters, where at least one of the second one or more parameters are inherited from the first one or more parameters, where the first configuration and the second configuration are based on UE reported capabilities.

Aspect 30 is the method of aspect 29, where at least one of the first one or more parameters or the second one or more parameters indicate one or more of: first characteristics of wake up monitoring occasions of the second radio, second characteristics of reference signals of the second radio, third characteristics of synchronization signals of the second radio, fourth characteristics of wake up signals of the second radio, fifth characteristics of preamble signals associated with the wake up signals, sixth characteristics associated with physical downlink control channel (PDCCH) transmission, seventh characteristics associated with channel state information (CSI) or channel state information reference signals (CSI-RS), eighth characteristics associated with sounding reference signals (SRS), or ninth characteristics associated with at least one of transmission or reception of data.

Aspect 31 is the method of any of aspects 24-30, further including: transmitting radio resource control (RRC) signaling or medium access control (MAC) control element (MAC-CE) signaling that indicates at least one timer.

Aspect 32 is an apparatus for wireless communication at a network node including a memory and at least one processor coupled to the memory and based at least in part on information stored in the memory, the at least one processor is configured to perform a method in accordance with any of aspects 24-31.

Aspect 33 is an apparatus for wireless communications, including means for performing a method in accordance with any of aspects 24-31.

Aspect 34 is the apparatus of aspect 32 or 33 further including at least one of a transceiver or an antenna coupled to the at least one processor, where the at least one processor is configured to transmit the first configuration, transmit the second configuration, and transmit the wake up signal via at least one of the transceiver or the antenna.

Aspect 35 is a computer-readable medium (e.g., a non-transitory computer-readable medium) including instructions that, when executed by an apparatus, cause the apparatus to perform a method in accordance with any of aspects 24-31.

1. An apparatus for wireless communication at a user equipment (UE), comprising:
a memory; and
at least one processor coupled to the memory and, based at least in part on information stored in the memory, the at least one processor is configured to:
monitor, via a first radio, a bandwidth part (BWP) based on a first configuration;
switch, based on an occurrence of at least one condition, to monitoring a subband based on a second configuration and via a second radio having a lower power consumption than the first radio; and
wake up to receive communication in response to receiving, via the second radio, a wake up signal in the subband.

2. The apparatus of claim 1, wherein the occurrence of the at least one condition includes an expiration of a BWP inactivity timer.

3. The apparatus of claim 1, wherein the occurrence of the at least one condition includes an expiration of a timer, wherein the timer is different than a BWP inactivity timer.

4. The apparatus of claim 3, wherein the timer is associated with a first duration and the BWP inactivity timer is associated with a second duration, wherein the first duration is less than the second duration.

5. The apparatus of claim 1, wherein the subband is within the BWP.

6. The apparatus of claim 1, wherein the subband is within a first BWP that is different than the BWP.

7. The apparatus of claim 1, wherein the at least one processor is further configured to:
switch, prior to switch to monitoring the subband via the second radio and subsequent to monitor the BWP via the first radio, to monitoring the subband via the first radio based on the occurrence of the at least one condition.

8. The apparatus of claim 7, wherein the at least one processor is further configured to:
place, subsequent to or concurrently with the switch to monitoring the subband via the second radio, the first radio in a sleep state.

9. The apparatus of claim 8, wherein to wake up to receive the communication, the at least one processor is configured to:
transition the first radio from the sleep state to an active state.

10. The apparatus of claim 1, wherein the at least one processor is further configured to:
receive, prior to monitor the BWP via the first radio, the first configuration; and
receive, prior to monitor the BWP via the first radio, the second configuration.

11. The apparatus of claim 10, wherein the first configuration includes first one or more parameters and the second configuration includes second one or more parameters, wherein at least one of the second one or more parameters are inherited from the first one or more parameters, wherein the first configuration and the second configuration are based on UE reported capabilities.

12. The apparatus of claim 11, wherein at least one of the first one or more parameters or the second one or more parameters indicate one or more of:
first characteristics of wake up monitoring occasions of the second radio,
second characteristics of reference signals of the second radio,
third characteristics of synchronization signals of the second radio,
fourth characteristics of wake up signals of the second radio,
fifth characteristics of preamble signals associated with the wake up signals,
sixth characteristics associated with physical downlink control channel (PDCCH) transmission,
seventh characteristics associated with channel state information (CSI) or channel state information reference signals (CSI-RS),
eighth characteristics associated with sounding reference signals (SRS), or
ninth characteristics associated with at least one of transmission or reception of data.

13. The apparatus of claim 1, wherein a preamble is used for synchronization, wherein the preamble is associated with at least a first periodicity and a first bandwidth that is different from or equivalent to a second periodicity and a second bandwidth associated with the wake up signal, wherein a length and a configuration of the preamble is different across different instances of wake up signals and is based in part on a low-power synchronization signal configuration or a low-power synchronization signal timing.

14. The apparatus of claim 1, wherein the at least one processor is further configured to:
receive a downlink control information (DCI), wherein the at least one condition occurs when the DCI is received.

15. The apparatus of claim 14, wherein the DCI indicates one or more of:
at least one timer,
the subband,
a different BWP, or
the subband within the different BWP.

16. The apparatus of claim 1, wherein the subband is within the BWP, wherein the at least one processor is further configured to:
switch to monitoring the BWP via the first radio in response to a first expiration of a first timer, wherein switch from monitoring the BWP via the first radio to monitoring the subband via the second radio is based on a second expiration of a second timer.

17. The apparatus of claim 1, wherein the subband is within the BWP, wherein the occurrence of the at least one condition includes a first expiration of a first timer, wherein the at least one processor is further configured to:
switch to monitoring a second BWP via the first radio in response to a second expiration of a second timer; and
switch to monitoring a second subband within the second BWP via the second radio in response to a third expiration of a third timer.

18. The apparatus of claim 1, wherein the at least one processor is further configured to:
receive radio resource control (RRC) signaling or medium access control (MAC) control element (MAC-CE) signaling that indicates at least one timer, wherein the occurrence of the at least one condition includes an expiration of the at least one timer.

19-20. (canceled)

21. A method of wireless communication at a user equipment (UE), comprising:
monitoring, via a first radio, a bandwidth part (BWP) based on a first configuration;
switching, based on an occurrence of at least one condition, to monitoring a subband based on a second configuration and via a second radio having a lower power consumption than the first radio; and
waking up to receive communication in response to receiving, via the second radio, a wake up signal in the subband.

22. An apparatus for wireless communication at a network node, comprising:
a memory; and
at least one processor coupled to the memory and, based at least in part on information stored in the memory, the at least one processor is configured to:
transmit, for a user equipment (UE), a first configuration associated with a first radio of the UE that is associated with a first power consumption, wherein the first radio is associated with a bandwidth part (BWP);
transmit, for the UE, a second configuration associated with a second radio of the UE, wherein the second radio is associated with a second power consumption that is less than the first power consumption; and
transmit, in a subband associated with the second radio of the UE, a wake up signal.

23-30. (canceled)
